(19) United States
(12) Patent Application Publication
(10) Pub. No.: US 2026/0197635 A1
(43) Pub. Date: Jul. 9, 2026

(54) SECURE ESTABLISHMENT METHOD, COMMUNICATION METHOD, AND APPARATUS

(71) Applicant: GUANGDONG OPPO MOBILE TELECOMMUNICATIONS CORP., LTD., Dongguan (CN)

(72) Inventors: Lihui XIONG, Dongguan (CN); Lu GAN, Dongguan (CN)

(73) Assignee: GUANGDONG OPPO MOBILE TELECOMMUNICATIONS CORP., LTD., Dongguan (CN)

(21) Appl. No.: 19/553,181

(22) Filed: Feb. 27, 2026

Related U.S. Application Data
(63) Continuation of application No. PCT/CN2022/123494, filed on Sep. 30, 2022.

(51) Int. Cl. H04W 12/03; H04W 12/106; H04W 76/14

(52) U.S. Cl. CPC H04W 12/03; H04W 12/106; H04W 76/14

(57) ABSTRACT

Provided are a secure establishment method, a communication method, and an apparatus. The method comprises: a source UE and a relay UE establish a communication link; and after the relay UE establishes a communication link with the source UE and a target UE respectively, the source UE and the target UE securely establish an end-to-end communication link. The solution of embodiments of the embodiments of this application provides a clear solution for the secure establishment of an end-to-end communication link between a source UE and a target UE.

### CROSS-REFERENCE TO RELATED APPLICATIONS

This application is a continuation of International Application No. PCT/CN2022/123494, filed on September 30, 2022, the disclosure of which is hereby incorporated by reference in its entirety.

### TECHNICAL FIELD

This application relates to the field of communications technologies, and more specifically, to a method for secure establishment, a communication method, and an apparatus.

### BACKGROUND

When a distance between a user equipment (UE) and a target UE is relatively long, the source UE may communicate with the target UE via a relay UE. In this scenario, there is no explicit solution for how to securely establish an end-to-end communication link between the source UE and the target UE.

### SUMMARY

This application provides a method for secure establishment, a communication method, and an apparatus. Various aspects of this application are described below.

According to a first aspect, a method for secure establishment is provided. The method includes: establishing, by a source UE, a communication link with a relay UE; and after the relay UE establishes a communication link with each of the source UE and a target UE, securely establishing, by the source UE, an end-to-end communication link with the target UE.

According to a second aspect, a communication method is provided. The method includes: establishing, by a target UE, a communication link with a relay UE; and after the relay UE establishes a communication link with each of the source UE and the target UE, securely establishing, by the target UE, an end-to-end communication link with the source UE.

According to a third aspect, a communication method is provided. The method includes: establishing, by a relay UE, a communication link with each of a source UE and a target UE; and after the relay UE establishes the communication link with each of the source UE and the target UE, forwarding, by the relay UE, an end-to-end message between the source UE and the target UE, where the end-to-end message is used by the source UE to securely establish an end-to-end communication link with the target UE.

According to a fourth aspect, a terminal device is provided, where the terminal device is a source UE, and the terminal device includes: an establishing unit, configured to establish a communication link with a relay UE, where the establishing unit is further configured to establish an end-to-end communication link with a target UE after the relay UE establishes a communication link with each of the source UE and the target UE.

According to a fifth aspect, a terminal device is provided, where the terminal device is a target UE, and the terminal device includes: an establishing unit, configured to establish a communication link with a relay UE, where the establishing unit is further configured to establish an end-to-end communication link with a source UE after the relay UE establishes a communication link with each of the source UE and the target UE.

According to a sixth aspect, a terminal device is provided, where the terminal device is a relay UE, and the terminal device includes: an establishing unit, configured to establish a communication link with each of a source UE and a target UE; and a forwarding unit, configured to forward an end-to-end message between the source UE and the target UE after the relay UE establishes the communication link with each of the source UE and the target UE, where the end-to-end message is used by the source UE to securely establish an end-to-end communication link with the target UE.

According to a seventh aspect, a terminal device is provided. The terminal device includes a memory and a processor, where the memory is configured to store a program, and the processor is configured to invoke the program in the memory to execute the method according to any one of the first aspect to the third aspect.

According to an eighth aspect, an apparatus is provided. The apparatus includes a processor configured to invoke the program from the memory, to execute the method according to any one of the first aspect to the third aspect.

According to a ninth aspect, a chip is provided. The chip includes a processor configured to invoke a program from a memory, to cause a device installed with the chip to execute the method according to any one of the first aspect to the third aspect.

According to a tenth aspect, a computer-readable storage medium is provided. The computer-readable storage medium stores a program, and the program causes a computer to execute the method according to any one of the first aspect to the third aspect.

According to an eleventh aspect, a computer program product is provided. The computer program product includes a program, and the program causes a computer to execute the method according to any one of the first aspect to the third aspect.

According to a twelfth aspect, a computer program is provided. The computer program causes a computer to execute the method according to any one of the first aspect to the third aspect.

### BRIEF DESCRIPTION OF DRAWINGS

FIG. 1 is an example diagram of a communications system that may be applied to embodiments of this application.

FIG. 2 is a schematic structural diagram of a key layer according to an embodiment of this application.

FIG. 3 is a schematic flowchart of establishing an end-to-end communication link.

FIG. 4 is a schematic flowchart of establishing a shared key between UEs.

FIG. 5 is a schematic flowchart of establishing a secure connection between UEs.

FIG. 6 is a schematic diagram of a user plane protocol stack using a layer-2 relay.

FIG. 7 is a schematic diagram of a control plane protocol stack using a layer-2 relay.

FIG. 8 is a schematic flowchart of establishing an end-to-end communication link by using a relay UE according to a related technology.

FIG. 9 is a schematic flowchart of a method for secure establishment according to an embodiment of this application.

FIG. 10 is a schematic flowchart of establishing a shared key between UEs according to an embodiment of this application.

FIG. 11 is a schematic flowchart of establishing a secure connection between UEs according to an embodiment of this application.

FIG. 12 is another schematic flowchart of establishing a shared key between UEs according to an embodiment of this application.

FIG. 13 is another schematic flowchart of establishing a secure connection between UEs according to an embodiment of this application.

FIG. 14 is a schematic block diagram of a source UE according to an embodiment of this application.

FIG. 15 is a schematic block diagram of a target UE according to an embodiment of this application.

FIG. 16 is a schematic block diagram of a relay UE according to an embodiment of this application.

FIG. 17 is a schematic structural diagram of a communications apparatus according to an embodiment of this application.

### DESCRIPTION OF EMBODIMENTS

Technical solutions in this application are described below with reference to the accompanying drawings.

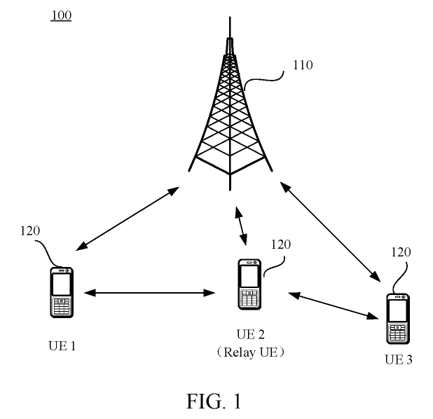

FIG. 1 shows a wireless communications system 100 to which embodiments of this application are applied. The wireless communications system 100 may include a network device 110 and a user equipment (UE) 120. The network device 110 may be a device in communication with the UE 120. The network device 110 may provide network coverage for a specific geographic area, and may communicate with the UE 120 (such as a UE 1, UE 2, and UE 3 in FIG. 1) located within the coverage. The UE 120 may access a network (for example, a wireless network) by using the network device 110. Optionally, the wireless communications system 100 may further include another network entity such as a network controller or a mobility management entity, which is not limited in embodiments of this application.

It should be understood that the technical solutions in embodiments of this application may be applied to various communications systems, for example, a fifth generation (5G) system or a new radio (NR), a long term evolution (LTE) system, an LTE frequency division duplex (FDD) system, and an LTE time division duplex (TDD). The technical solutions provided in this application may further be applied to a future communications system, such as a 6th generation mobile communications system or a satellite communications system.

The UE in embodiments of this application may also be referred to as a terminal device, an access terminal, a subscriber unit, a subscriber station, a mobile site, a mobile station (MS), a mobile terminal (MT), a remote station, a remote terminal, a mobile device, a user terminal, a terminal, a wireless communications device, a user agent, or a user apparatus. The UE in embodiments of this application may be a device providing a user with voice and/or data connectivity and capable of connecting people, objects, and machines, such as a handheld device or vehicle-mounted device having a wireless connection function. The UE in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or the like. Optionally, the UE may be configured to function as a base station. For example, the UE may function as a scheduling entity, which provides a sidelink signal between UEs in V2X, D2D, or the like. For example, a cellular phone and a vehicle communicate with each other through a sidelink signal. A cellular phone and a smart home device communicate with each other, without relaying a communication signal through a base station.

The network device in embodiments of this application may be a device for communicating with the UE. The network device may also be referred to as an access network device or a radio access network device. For example, the network device may be a base station. The network device in embodiments of this application may be a radio access network (RAN) node (or device) that connects the UE to a wireless network. The base station may broadly cover various names in the following, or may be replaced with a name in the following, for example, a NodeB, an evolved NodeB (eNB), a next generation NodeB (gNB), a relay station, an access point, a transmitting and receiving point (TRP), a transmitting point (TP), a primary MeNB, a secondary SeNB, a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof.

The base station may be a stationary or mobile base station. For example, a helicopter or an unmanned aerial vehicle may be configured to act as a mobile base station, and one or more cells may move based on a position of the mobile base station. In another example, a helicopter or an unmanned aerial vehicle may be configured to serve as a device in communication with another base station.

The network device and the terminal device may be deployed on land, including being indoors or outdoors, handheld, or vehicle-mounted, may be deployed on a water surface, or may be deployed on a plane, a balloon, or a satellite in the air. In embodiments of this application, a scenario of the network device and the terminal device is not limited.

It should be understood that all or some of functions of the communications device (such as the network device or the terminal device) in this application may also be implemented by software functions running on hardware, or by virtualization functions instantiated on a platform (for example, a cloud platform).

UEs shown in FIG. 1 may communicate with each other by using a sidelink (SL). Sidelink communication may also be referred to as proximity service (ProSe) communication, unilateral communication, sidelink communication, device-to-device (D2D) communication, or end-to-end (E2E) communication.

The UEs may communicate with each other by using an interface, and the interface may be used for information transmission on a data plane and a control plane. The interface may be a proximity communication 5 (PC5) interface or a sidelink interface. For ease of description, the following uses a PC5 interface as an example for description.

A UE having a ProSe capability may communicate directly with another UE having the ProSe capability through the PC5 interface. A UE having a ProSe capability may discover another UE having the ProSe capability through a discovery process. For example, a UE 1 may broadcast information about a UE that the UE 1 expects to discover, for example, service information (indicating expecting to discover a UE supporting the service), and a user identifier of a target UE at an application layer. A frame structure of a data packet for the UE 1 to broadcast a message may carry a link layer (namely, layer 2) identity (ID) of the UE 1. The UE 2 determines, based on a received broadcast message, that the UE 2 is a UE that UE 1 expects to discover, and obtains the layer 2 (L2) ID of the UE 1. The UE 2 may transmit a response message to the UE 1, where the response message carries information about the UE 2, such as service information supported by the UE 2 and a user identity of the UE 2 at the application layer. A frame structure of the response message transmitted by the UE 2 carries the L2 ID of the UE 2, and the UE 1 learns the information about the UE 2 and the L2 ID of the UE 2.

After obtaining the L2 ID of the UE 2, the UE 1 may transmit a direct communication request to the UE 2 to request for establishment of a PC5 connection. A communication link established between the UE 1 and the UE 2 may be referred to as a unicast link or a per-hop link.

The UE 1 may also be referred to as a source UE, and the UE 2 may also be referred to as a target UE.

To ensure data transmission security, an end-to-end secure communication link may be established between the UE 1 and the UE 2. The secure communication link may include security context, and the security context may be used to encrypt communication data between the UE 1 and the UE 2.

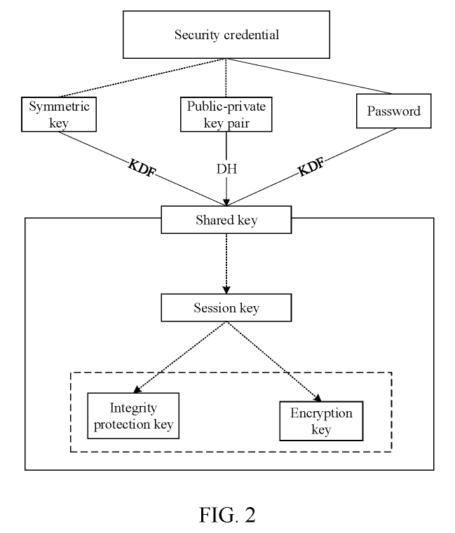

Before description of the security context, a key level in embodiments of this application is first described. Referring to FIG. 2, the key level in embodiments of this application may include the following: a security credential, a shared key (which may be represented by K_{D} or a K_{NRP}, and K_{D} is used as an example below), a session key (which may be represented by K_{D-sess} or K_{NRP-sess}, and K_{D-sess} is used as an example below), an integrity protection key (which may be represented by K_{D-int} or an NRPIK, and K_{D-int} is used as an example below), and an encryption key (which may be represented by K_{D-enc} or NRPEK, and K_{D-enc} is used as an example below). The encryption key may also be referred to as a confidentiality protection key.

The security credential is a security source of the PC5 unicast link. The security credential between the source UE and the target UE may be a symmetric key, a public-private key pair, a password, or the like according to a specific case. A lower-level key K_{D} may be generated between the source UE and the target UE by using mutual authentication signaling.

A length of the key K_{D} is at least 256 bits and may be generated by the source UE and the target UE according to a key credential in an authentication and key establishment procedure. In addition, the key may be updated by rerunning the authentication and key establishment procedure. The key K_{D} may be used to generate a next-level key K_{D-sess}. The key may be saved even if there is no active communication session between the source UE and the target UE. A K_{D} ID may be used to identify K_{D}.

A length of the key K_{D-sess} is at least 256 bits, and the key is used to derive a next-level integrity protection key or an encryption protection key. The key may be refreshed by rerunning a secure connection establishment procedure or a related key update procedure. A K_{D-sess} ID may be used to identify K_{D-sess}. The key may be derived by K_{D} by using a key derivation algorithm such as HMAC-SHA-256 or HMAC-SM3. In a process of generating K_{D-sess}, an input key is K_{D}, and an input parameter is a random number Nonce_1 and a random number Nonce_2. In addition, a length of the random number and another system setting parameter may be used as an optional input parameter.

A length of the key K_{D-int} is at least 128 bits. The key can be used for integrity protection of E2E data. The key may be derived by K_{D-sess} by using a key derivation algorithm such as HMAC-SHA-256 or HMAC-SM3. In a process of generating K_{D-int}, an input key may be K_{D-sess}, and the input parameter may include a selected algorithm type identifier (such as an “integrity protection algorithm” or setting a specific value to identify), a length of the identifier, an integrity protection algorithm, and a length of the identifier. In addition, another system setting parameter may be used as an optional input parameter. When K_{D-sess} is automatically refreshed, the key is automatically updated.

A length of the key K_{D-enc} is at least 128 bits. The key may be used for encryption protection of E2E data. The key may be derived by K_{D-sess} by using a key derivation algorithm such as HMAC-SHA-256 or HMAC-SM3. In a process of generating K_{D-enc}, an input key may be K_{D-sess}, and the input parameter may include a selected algorithm type identifier (such as a “confidentiality protection algorithm” or setting a specific value to identify), a length of the identifier, a confidentiality protection algorithm, and a length of the identifier. In addition, another system setting parameter may be used as an optional input parameter. When K_{D-sess} is automatically refreshed, the key is automatically updated.

According to different keys used by a UE for encryption, a security status of the UE may include configuration security, partial security, and full security. For the configuration security, the UE only has a security credential. For the partial security, the UE has recently communicated with another UE and has K_{D} shared with the another UE, but no other derived key. For the full security, the UE actually communicates with another UE and has K_{D} and security context of each unicast link.

The UE may establish security context for each unicast link. The security context may include one or more of the following: a session key, an integrity protection key, a confidentiality protection key, selected confidentiality, an integrity algorithm, and a packet data convergence protocol (PDCP) counter used by a respective bearer. When a unicast link is reset with a password, the UE updates security context associated with the unicast link. Once the unicast link is released, the UE deletes the security context associated with the unicast link.

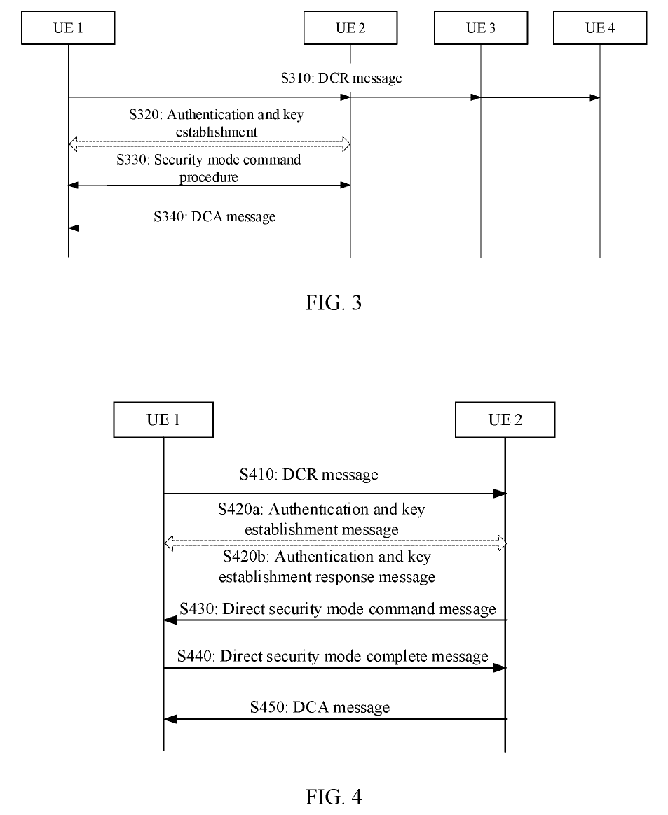

With reference to FIG. 3 to FIG. 5, the following describes a process of establishing a communication link between UEs.

Referring to FIG. 3, in step S310, a UE 1 transmits a direct communication request (DCR) message. The DCR message is allowed to be received by a plurality of UEs. As shown in FIG. 3, a UE 2, a UE 3, and a UE 4 can all receive the DCR message.

In step S320, after receiving the DCR message, the UE 2, UE 3, and UE 4 may determine whether to respond to the DCR message. Assuming that the UE 2 selects to respond to the DCR message, the UE 2 may execute a direct authentication and key generation establishment procedure (Direct Auth and Key Establishment procedure) with the UE 1, so as to generate a key K_{D}.

If there is already a key K_{D} between the UE 1 and the UE 2, step S320 may not be performed.

In step S330, the UE 1 and the UE 2 run a direct security mode command procedure (Direct Security Mode Command procedure) to continue a connection establishment procedure.

If the connection is successfully established, information transmitted by the UE 1 to another UE may be included in a direct security mode complete message transmitted by the UE 1 and transmitted as a part of the direct security mode procedure.

In step S340, the UE 2 transmits a direct communication response (DCA) message to the UE 1.

FIG. 4 is a schematic flowchart of establishing a shared key between a UE1 and a UE2 according to an embodiment of this application.

Referring to FIG. 4, in step S410, when the UE 1 determines that a PC5 connection is required to be established between the UE 1 and another UE, the UE 1 may transmit a DCR message, and the DCR message is received by the UE 2.

In some embodiments, the DCR message may include Key_Est_Info. If the UE 1 does not require an integrity security policy of a signal, Key_Est_Info may not be included in the DCR message. Key_Est_Info may be understood as a general container on a PC5 interface. Identity authentication may be performed in Key_Est_Info. The Key_Est_Info may include different data required for key establishment. Such data is transparent at a PC5 layer, that is, the PC5 layer is unnecessary to understand content included in Key_Est_Info.

In step S420a, the UE 2 transmits a direct authentication and key establishment (Direct Auth and Key Establish) message to the UE 1. The direct authentication and key establishment message may include Key_Est_Info.

In step S420b, the UE 1 transmits a direct authentication and key establishment response (Direct Auth and Key Establish Response) message to the UE 2. The direct authentication and key establishment response message may include Key_Est_Info.

In step S430, the UE 2 may calculate a key K_{D}. The UE 2 transmits a direct security mode command (Direct Security Mode Command) message to the UE 1. The direct security mode command message may include Key_Est_Info and a most significant bit (MSB) of a K_{D} ID. The UE 2 may select the MSB of the K_{D} ID to uniquely identify K_{D} at the UE 2.

In step S440, after receiving the direct security mode command message, the UE 1 may calculate K_{D} based on Key_Est_Info. In addition, the UE 1 may also select a least significant bit (least significant bit, LSB) of the K_{D} ID, to uniquely identify K_{D} at the UE 1. The UE 1 may further generate a K_{D} ID based on the received MSB of the K_{D} ID and the LSB of the K_{D} ID selected by the UE 1 and store the complete K_{D} ID together with K_{D}.

In step S450, the UE 1 transmits a direct security mode complete (Direct Security Mode Complete) message to the UE 2. The security mode complete message may include the LSB of the K_{D} ID.

After receiving the security mode complete message, the UE 2 may generate a complete K_{D} ID based on an MSB of the K_{D} ID selected by the UE 2 and the received LSB of the K_{D} ID. In addition, the UE 2 may further store the complete K_{D} ID together with K_{D}.

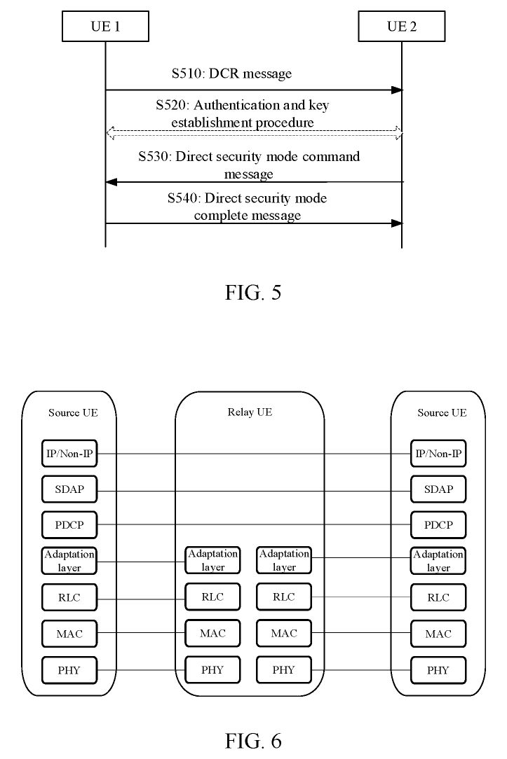

FIG. 5 shows a schematic flowchart of establishing an end-to-end secure connection between a UE 1 and a UE 2.

Before description of FIG. 5, a security policy involved in embodiments of this application is first described. The security policy in embodiments of this application may be set for different protection keys. The protection key may include, for example, one or more of the following: a signal integrity protection key, a signal confidentiality protection key, a user plane integrity protection key, or a user plane confidentiality protection key.

The security policy may include one or more of the following: REQUIRED, PREFERRED, or NOT NEED. REQUIRED indicates that a UE should accept connections only in a case of protecting traffic by using a non-null confidentiality algorithm or a non-null integrity algorithm. NOT NEED indicates that the UE can only establish a connection without security. PREFERRED indicates that the UE is allowed to attempt to establish a security connection but is allowed to accept a connection without security.

Referring to FIG. 5, in step S510, the UE 1 transmits a DCR message to the UE 2.

The DCR message may include security capabilities (UE 1 security capabilities) of the UE 1 and a signaling security policy of the UE 1. The security capabilities of the UE 1 may include a list of algorithms that the UE 1 will accept for this connection.

If the signaling integrity protection policy of the UE 1 is “REQUIRED” or “PREFERRED”, the DCR message may further include Nonce_1 and an MSB of a K_{D sess} ID. The Nonce_1 may be used to generate K_{D sess}.

The UE 1 needs to select the MSB of the K_{D sess} ID, so that the UE 1 can locally identify security context created in this process by using the K_{D sess} ID.

If the UE 1 has K_{D} corresponding to the UE 2, the DCR message may also include a K_{D} ID. If there is no K_{D} ID in the DCR message, it indicates that no K_{D} is generated between the UE 1 and the UE 2.

In addition, the DCR message may further include Key_Est_Info.

In step S520, the UE 2 initiates initialization of a direct authentication and key establishment procedure to the UE 1.

If the signaling security policy of the UE 1 is “NOT NEED” and a security policy of the UE 2 is “REQUIRED”, the UE 2 should reject the DCR of the UE 1. If the signaling security policy of the UE 1 is “REQUIRED” and the security policy of the UE 2 is “NOT NEED”, the UE 2 should reject the DCR of the UE 1.

If the UE 2 has no K_{D} and K_{D} ID pair indicated in step S510, and signaling is required to establish a key of a specific case, the UE 2 needs to perform step S520.

If the direct authentication and key establishment procedure is started, the UE 1 and the UE 2 may perform mutual authentication by using information exchanged in Key_Est_Info. An authentication method used by the UE 1 and the UE 2 is specific to an application procedure. In the direct authentication and key establishment procedure, any UE is allowed to reject an authentication process.

In step S530, the UE 2 transmits a direct security mode command (Direct Security Mode Command) message to the UE 1.

Unless the UE 2 selects a null integrity algorithm, an MSB of the K_{D} ID is required to be included in the direct security mode command message. If a new K_{D} is required to be generated, the security mode command message may further include Key_Est_Info.

In some embodiments, the security mode command message may further include an algorithm (choosen_alg) parameter selected by the UE 2. The algorithm herein may be an integrity protection algorithm and/or a confidentiality protection algorithm. A non-null security algorithm in the selected algorithm indicates that corresponding security protection is activated, and the UE will use the security algorithm to protect data in the message. The null security algorithm in the selected algorithm indicates that corresponding security protection is not performed. If a signaling integrity security policy of the UE 2 is “NOT NEED” or “PREFERRED”, the selected algorithm may use only the null integrity algorithm.

In some embodiments, the security mode command message may further include the security capabilities of the UE 1 and the signaling security policy of the UE 1 to provide protection against bid rejection attacks. When the null integrity algorithm is selected, a null confidentiality algorithm should also be selected. The UE 2 should set the K_{D sess} ID of security context to all zero values.

In some embodiments, when the UE 2 decides to activate at least integrity security protection of the connection, the security mode command message may include Nonce_2 and an LSB of the K_{D sess} ID. The Nonce_2 is used to calculate a session key. The LSB of the K_{D sess} ID may be used by the UE 2 to locally identify the security context created by the process.

In some embodiments, the UE 2 may calculate the session key based on K_{D}, the Nonce_1, and the Nonce_2. The UE 2 may further derive an encryption key and/or an integrity protection key based on the session key and the selected algorithm.

In some embodiments, the UE 2 may generate the K_{D sess} ID based on the MSB of the K_{D sess} ID received in step S510 and the LSB of the K_{D sess} ID transmitted in step S530.

In step S540, after receiving the direct security mode command message transmitted by the UE 2, the UE 1 may transmit a direct security mode command complete message to the UE 2.

In some embodiments, after receiving the direct security mode command message, the UE 1 may check the algorithm selected by the UE 2. The null integrity algorithm should be accepted only when the signaling integrity protection security policy of the UE 1 is NOT NEED or PREFERRED. If the null integrity algorithm is selected for signaling integrity protection, the UE 2 may also check the security capabilities of the UE 1 and the signaling security policy of the UE that are returned by the UE 2, to avoid rejection attacks.

In some embodiments, the UE 1 may generate the K_{D sess} ID based on the MSB of the K_{D sess} ID transmitted in step S510 and the LSB of the K_{D sess} ID received in step S530.

In some embodiments, the UE 1 may calculate the session key, the integrity protection key, and the confidentiality protection key in the same manner as the UE 2.

In some embodiments, the UE 1 may create security context associated with the K_{D sess} ID. In a subsequent communication process, the UE 1 may protect information by using new security context, and may receive a signaling message by using the new security context.

After the UE 1 transmits the security mode command complete message to the UE 2, an end-to-end secure communication link is established between the UE 1 and the UE 2.

After the communication link is securely established between the UE 1 and the UE 2, signaling and data between the UE 1 and the UE 2 may be protected at a PDCP layer. Once security is established for the connection, all signaling messages for the connection will be protected using the selected algorithm.

A key ID used in the data and a least significant bit of a counter are carried in a PDCP header. If integrity protection is activated, the PDCP header may further carry a message authentication code (MAC) required for the integrity protection.

Different target UEs may establish different security contexts with a source UE. If both the UE 2 and a UE 3 respond to the DCR message of the UE 1, security context established between the UE 1 and the UE 2 is different from security context established between the UE 1 and the UE 3.

The UE 1 described above may be referred to as a source UE, and the UE 2 may be referred to as a target UE.

The source UE described above communicates directly with the target UE. When the source UE and the target UE are far away from each other, a relay UE may be used for assistance. The source UE may communicate with the target UE by using the relay UE, and the target UE may communicate with the source UE by using the relay UE.

Still referring to FIG. 1, the UE 1 and the UE 3 in FIG. 1 are far away from each other, the UE 1 and the UE 3 may communicate by using the UE 2, and the UE 2 may be used as a relay UE between the UE 1 and the UE 3.

FIG. 1 shows a scenario in which the UE 1 and the UE 3 communicate with each other by using a relay UE (that is, the UE 2). Embodiment of this application is not limited thereto. The UE 1 and the UE 3 may alternatively communicate with each other by using a plurality of relay UEs.

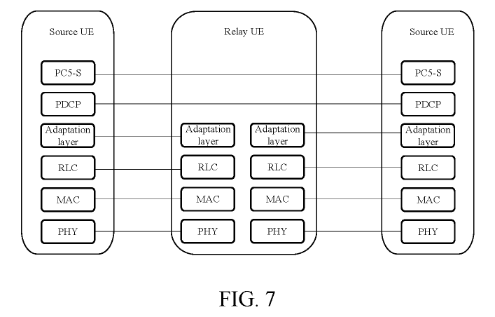

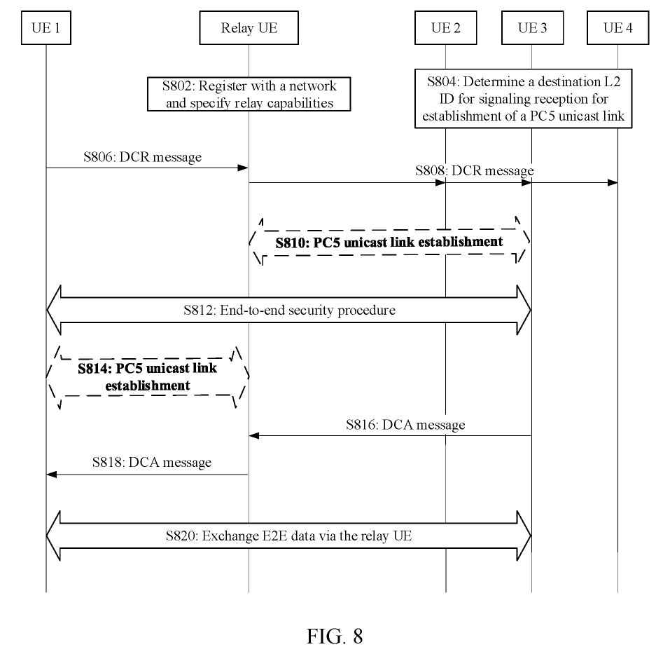

FIG. 6 and FIG. 7 respectively illustrate a user plane protocol stack and a control plane protocol stack using a layer 2 relay. It may be learned from FIG. 6 and FIG. 7 that an adaptation layer is disposed for each of a source UE, a relay UE, and a target UE, and the adaptation layer may be configured to relay and forward data. The adaptation layer may be disposed above a radio link control (RLC) layer and below a PDCP layer.

There is no relevant provision in current protocols on how to securely establish an end-to-end communication link between a source UE and a target UE that communicate with each other by using a relay UE.

A related technology provides a method for secure establishment, as shown in FIG. 8. The following describes the steps shown in FIG. 8.

In step S802, a relay UE registers with a network and specifies relay capabilities of the relay UE. The relay UE may use an existing program described in TS 23.304 to provide relay policy parameters for a relay from a UE to a UE using relay policy parameters from the network.

In step S804, a target UE (that is, a UE 2, a UE 3, and a UE 4) may determine a destination L2 ID (that is, broadcast the layer 2 ID) for signaling reception for establishment of a PC5 unicast link according to the provision of Article 6.4.3.1 of TS 23.304.

In step S806, on a source UE (that is, a UE 1), the application layer provides application information to a Prose layer for PC5 unicast communication. The application information may include ProSe service information and an application layer ID of the source UE. In some embodiments, the application information may further include an application layer ID of the target UE, such as information specified in Article 6.4.3.1 of TS 23.304.

The Prose layer may trigger a link establishment procedure by transmitting a DCR message that includes a security parameter specified in TS 33.536 [9].

The DCR message is transmitted without an adaptation layer header. The DCR message may be used for direct and/or indirect link establishment. In some embodiments, the target UE directly receiving the DCR from the UE 1 may perform a link establishment procedure according to a procedure in a conventional technology.

In step S808, after receiving the DCR message, the relay UE may verify whether the relay UE is configured to relay the application program. The relay UE may compare announcement Prose service information with a provided relay policy/parameter.

The relay UE may use its own L2 ID as a source L2 ID to forward the DCR message and designate an L2 ID of the target UE as the destination L2 ID. The destination L2 ID may be specified in the received DCR message, may be obtained in a discovery process between the relay UE and the target UE, or may be a broadcast L2 ID.

An adapter header may be added to the relay UE, and the adapter header may include information identifying the UE 1. The DCR message forwarded by the relay UE may include its unique relay ID and a relay-specific MSB of a K_{D-sess} ID. The relay UE may maintain association between a UE 1 MSB of a K_{D-sess} ID specified in the DCR message and the relay-specific MSB of the K_{D-sess} ID specified in the forwarded DCR message. Any subsequent E2E message (that is, PC5-S and data) may be forwarded based on a UE ID specified in the adaptation header.

In step S810, the target UE (that is, the UE 3) receives the DCR message by using the relay UE. The UE 3 is interested in the application program transmitted by the UE 1. Therefore, the UE 3 may trigger establishment of the PC5 unicast link with the relay UE. If no PC5 unicast link has been established between the UE 3 and the relay EU, the UE 3 may trigger the establishment of the PC5 unicast link with the relay UE.

In step S812, the UE 3 initiates a security process (that is, a PC5 authentication and/or a PC5 direct security mode process) by using the selected relay UE (that is, directly link to the relay UE by using the PC5) to continue an E2E link establishment procedure.

A packet header of an adaptation layer may be added to the UE 3, and the packet header may include information that identifies the UE 1 received with the DCR message, an LSB of the K_{D-sess} ID (LSB of K_{D-sess} ID), and an identity of the UE 3. The UE 3 may associate the MSB of the K_{D-sess} ID received in the DCR message with the LSB of the K_{D-sess} ID of the UE 3 to create security context for an extended link. A first message (that is, a direct link authentication request or a direct security mode command (Direct Link Authentication Request or Direct Security Mode Command)) transmitted by the UE 3 to the UE 1 includes a relay ID.

The relay UE forwards the message from the UE 3 to the UE 1, where relay-specific information identifying the UE 3 is included in the adaptation header. The relay UE may further specify a relay-specific LSB of the K_{D-sess} ID associated with the UE 3 and the MSB of the UE 1 that are received with the DCR message. In addition, the message forwarded by the relay UE to the UE 1 may include information identifying the UE 1 and associated with the DCR message. For example, the message may include a UE 1 L2 ID used when the UE 1 transmits the DCR message.

The relay UE may use its L2 ID as a source ID and the UE 1 L2 ID as a destination ID. The relay UE may maintain an association of the UE 3 LSB of the K_{D-sess} ID specified in the message received from the UE 3 with the relay-specific LSB associated with the K_{D-sess} ID of the UE 3.

In step S814, when receiving the first message from the UE 3 via the relay UE, the UE 1 extracts a relay ID and verifies whether a PC5 unicast link has been established between the UE 1 and the relay UE. If no PC5 unicast link is established between the UE 1 and the relay UE, the UE 1 triggers a PC5 unicast link establishment procedure by using the relay UE and then continues the security process in step S812. The UE 1 tracks the LSB of the K_{D-sess} ID specified in the received message (that is, the LSB K_{D-sess} ID is associated with the UE 3), and creates security context for an extended link by using the LSB of the K_{D-sess} ID.

In step S816, once the E2E link security establishment process is completed, the UE 3 may transmit a DCA message to the UE 1 by using the relay UE, to complete the E2E link establishment procedure.

In step S818, the UE 1 receives the DCA message. By using the relay UE, a secure “extended” unicast link is established between the UE 1 and the UE 3. The extended link is an end-to-end secure link, that is, a security association is created between the UE 1 and the UE 3.

In step S820, the UE 1 and the UE 3 exchange E2E data by using the header of the adaptation layer via the relay UE. The relay UE replaces a field specified in the adaptation header with a relay-specific identifier.

For communication via the relay UE, a communication link between the source UE and the relay UE and a communication link between the relay UE and the target UE may be referred to as a per-hop link.

In the security establishment process shown in FIG. 8, the end-to-end security process, that is, in step S812, is performed in a procedure of establishing the unicast link. In other words, before a PC5 unicast link is established between the UE 1 and the relay UE, an end-to-end security procedure is first performed, which conflicts with a conclusion and a procedure of the existing SA2.

Based on this, an embodiment of this application provides a method for secure establishment. For relay communication between UEs, a clear solution is provided for secure establishment of an end-to-end communication link between a source UE and a target UE. In addition, after a communication link between a relay UE and the source UE, and a communication link between the relay UE and the target UE are established, the end-to-end communication link between the source UE and the target UE is securely established, so that an end-to-end security establishment process can be more compatible with an existing protocol, thereby avoiding a conflict with the existing protocol.

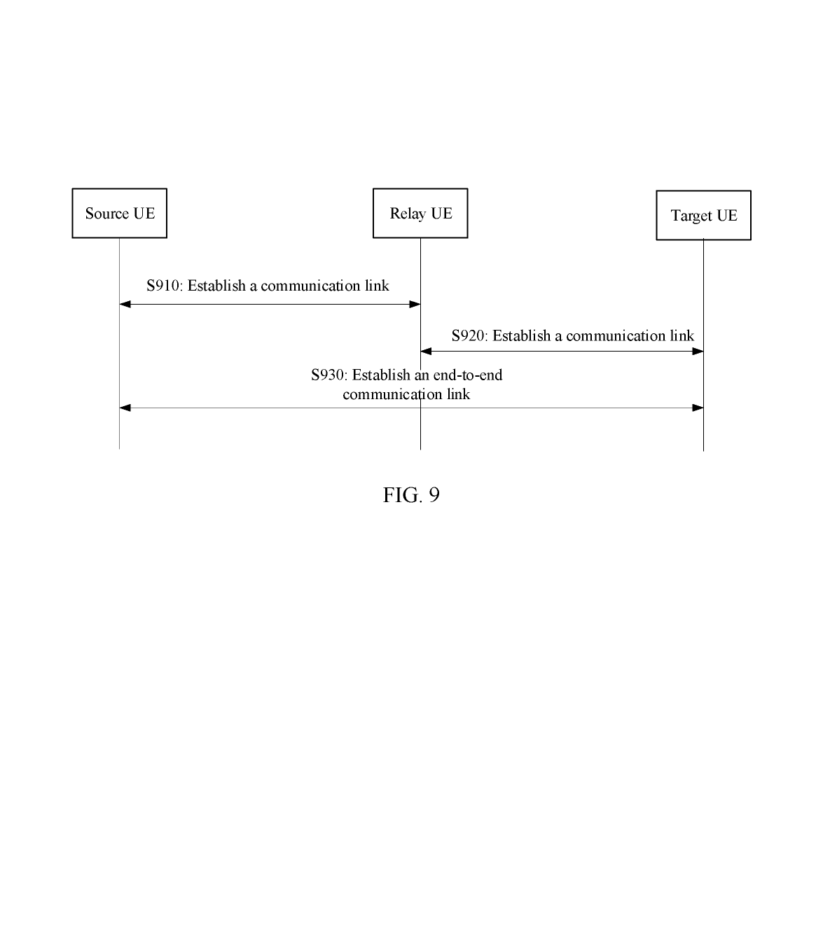

The following describes solutions of embodiments of this application in detail with reference to FIG. 9.

In step S910, a source UE establishes a communication link with a relay UE, or the relay UE establishes a communication link with the source UE.

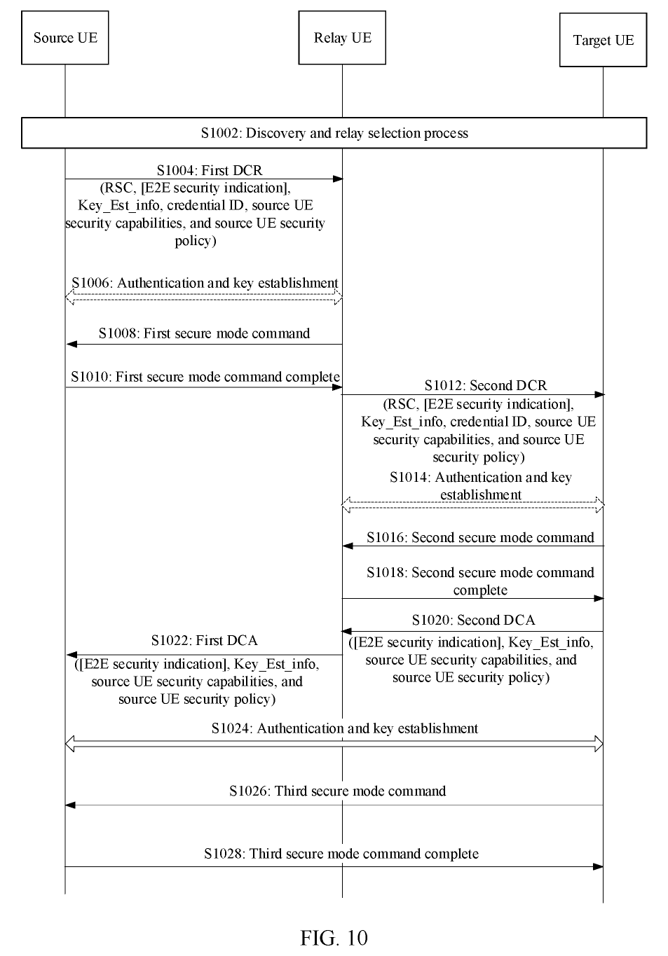

The communication link between the source UE and the relay UE may be a PC5 unicast communication link. The communication link may also be referred to as a per-hop communication link. A process of establishing the communication link between the source UE and the relay UE is described below with reference to FIG. 10 to FIG. 13.

The communication link between the source UE and the relay UE may be a securely established communication link or may be a non-securely established communication link. Whether the communication link between the source UE and the relay UE is a securely established communication link may be determined depending on a security manner negotiated between the source UE and a target UE. If the source UE and the target UE negotiate to use per-hop link security, the communication link between the source UE and the relay UE is the securely established communication link. The source UE and the relay UE may establish a PC5 unicast communication link and also establish per-hop link security. If the source UE and the target UE negotiate not to use per-hop link security, the communication link between the source UE and the relay UE may be the non-securely established communication link.

A process of establishing the per-hop communication link between the source UE and the relay UE may include the following procedures. The source UE transmits a first DCR message to the relay UE. After receiving the first DCR message, the relay UE may execute a first authentication and key establishment procedure with the source UE. The relay UE may transmit a first security mode command message to the source UE. After receiving the first security mode command message, the source UE may transmit a first security mode complete message to the relay UE.

In step S920, the target UE establishes a communication link with the relay UE, or the relay UE establishes a communication link with the target UE.

The communication link established between the target UE and the relay UE may be a PC5 unicast communication link. The communication link may also be referred to as a per-hop communication link. A process of establishing the communication link between the target UE and the relay UE is described below.

The communication link between the target UE and the relay UE may be a securely established communication link or may be a non-securely established communication link. Whether the communication link between the source UE and the relay UE is a securely established communication link may be determined depending on a security manner negotiated between the source UE and the target UE. If the source UE and the target UE negotiate to use per-hop link security, the communication link between the target UE and the relay UE is the securely established communication link. The target UE and the relay UE may establish a PC5 unicast communication link and also establish per-hop link security. If the source UE and the target UE negotiate not to use per-hop link security, the communication link between the target UE and the relay UE may be the non-securely established communication link.

A process of establishing the per-hop communication link between the relay UE and the target UE may include the following procedures. The relay UE transmits a second DCR message to the target UE. After receiving the second DCR message, the target UE may execute a second authentication and key establishment procedure with the relay UE. The target UE may transmit a second security mode command message to the relay UE. After receiving the second security mode command message, the relay UE may transmit a second security mode complete message to the target UE.

In some embodiments, the target UE may further transmit a second DCA message to the relay UE. After receiving the second DCA message, the relay UE may transmit a first DCA message to the source UE.

Step S930: After the relay UE establishes the communication link with each of the source UE and the target UE, the source UE securely establishes an end-to-end communication link with the target UE, or the target UE securely establishes an end-to-end communication link with the source UE. The end-to-end communication link between the source UE and the target UE may be an extended PC5 communication link.

For the relay UE, the relay UE may forward an end-to-end message between the source UE and the target UE, and the end-to-end message may be used by the source UE to securely establish the end-to-end communication link with the target UE. The securely established end-to-end communication link may also be referred to as an end-to-end secure communication link.

A manner of securely establishing the end-to-end communication link between the source UE and the target UE is not specifically limited in embodiments of this application. In an example, the source UE securely establishing the end-to-end communication link with the target UE may include one or more of the following: establishing, by the source UE, a shared key of the end-to-end communication link with the target UE; establishing, by the source UE, a session key of the end-to-end communication link with the target UE; establishing, by the source UE, an integrity protection key of the end-to-end communication link with the target UE; or establishing, by the source UE, an encryption key of the end-to-end communication link with the target UE.

The integrity protection key and the encryption key may be used to protect control plane signaling (such as PC5-S, and PCS-RRC) and user plane data.

A manner of triggering establishment of the communication link between the relay UE and the source UE, between the relay UE and the target UE is not specifically limited in embodiments of this application. For example, the relay UE may establish the communication link with each of the source UE and the target UE under trigger of the source UE. Establishing the communication link under trigger of the source UE may be more compatible with an existing protocol, and a change to the protocol is relatively small. Certainly, in some embodiments, the relay UE may establish the communication link with each of the source UE and the target EU under trigger of the target UE. The following describes a process of establishing a communication link by using an example in which the relay UE establishes the communication link with each of the source UE and the target UE under trigger of the source UE.

In some embodiments, under trigger of the source UE, a communication link is first established between the source UE and the relay UE in embodiments of this application, and after the communication link between the relay UE and the target UE is established, the communication link between the source UE and the relay UE is then established. Alternatively, under trigger of the source UE, the communication link between the source UE and the relay UE and the communication link between the relay UE and the target UE may be established simultaneously in embodiments of this application. In other words, the communication link between the relay UE and the target UE may be established in a process of establishing the communication link between the source UE and the relay UE.

In some embodiments, under trigger of a first direct communication request message transmitted by the source UE, the relay UE may establish the communication link with the source UE and/or the relay UE may establish the communication link with the target UE.

The source UE may transmit the first direct communication request message to the relay UE. The first direct communication request message may be used to trigger the relay UE to establish the communication link with the source UE. After receiving the first direct communication request message, the relay UE and the source UE execute a first security mode command (SMC) procedure. In some embodiments, the first security mode command procedure may include that: the relay UE transmits a first security mode command message to the source UE, and the source UE transmits a first security mode complete message to the relay UE. In some embodiments, the first security mode command procedure may be referred to as a direct security mode command procedure.

After the first security mode command procedure is completed, the relay UE may transmit a second direct communication request message to the target UE. The second direct communication request message may be used to trigger the target UE to establish a communication link with the relay UE. In response to the second direct communication request message, the target UE and the relay UE execute a second security mode command procedure. In some embodiments, the second security mode command procedure may include that: the target UE transmits a second security mode command message to the relay UE, and the relay UE transmits a second security mode complete message to the target UE. In some embodiments, the second security mode command procedure may be referred to as a direct security mode command procedure.

In response to completion of the second security mode command procedure, the target UE transmits a second direct communication accept message for the second direct communication request message to the relay UE. In response to the second direct communication accept message, the relay UE transmits a first direct communication accept message for the first direct communication request message to the source UE.

In some embodiments, the source UE securely establishing the end-to-end communication link with the target UE may include: executing, by the source UE, a third security mode command procedure with the target UE. The third security mode command procedure may include that: the source UE transmits a third security mode command message to the target UE, and the target UE transmits a third security mode command complete message to the source UE. In some embodiments, the third security mode command procedure may be referred to as a direct security mode command procedure. Considering that communication between the source UE and the target UE needs to be forwarded by the relay UE, the third security mode command procedure may also be referred to as an indirect security mode command procedure.

In some embodiments, the source UE and the target UE may execute the third security mode command procedure under trigger of the first direct communication request. In some other embodiments, the source UE and the target UE may execute the third security mode command procedure under trigger of a third direct communication request. The following describes a process in which the source UE and the target UE execute the third security mode command under trigger of the third direct communication request.

Before the source UE and the target UE execute the third security mode command procedure, the source UE may transmit the third direct communication request to the relay UE, where the third direct communication request is used to trigger the relay UE to transmit a fourth direct communication request to the target UE. In response to the third direct communication request, the relay UE transmits the fourth direct communication request to the target UE. The fourth direct communication request is used to trigger the target UE to securely establish the end-to-end communication link with the source UE.

The third direct communication request may include information required for securely establishing the end-to-end communication link. In some embodiments, the third direct communication request may include one or more of the following information: information for instructing securely establishing the end-to-end communication link; or security data required for securely establishing the end-to-end communication link.

In some embodiments, the source UE may transmit the third direct communication request to the relay UE after receiving the first direct communication accept message. In some embodiments, the source UE may transmit the third direct communication request to the relay UE when a security negotiation result is that end-to-end security is required to be established or the source UE chooses to establish end-to-end security.

The end-to-end communication link in embodiments of this application may be established in a security manner negotiated by the source UE and the target UE. In some embodiments, the source UE and the target UE may negotiate whether to execute a security establishment process for a communication link. If the security establishment process is required to be executed for a communication link, the source UE and the target UE need to execute the security establishment process for the communication link. If the security establishment process is not required to be executed for a communication link, the source UE and the target UE may not execute the security establishment process for the communication link but establish a common communication link.

A security negotiation process is not specifically limited in embodiments of this application. For example, the security negotiation process may be included in mutual authentication processes between the source UE, the relay UE, and the target UE. For another example, the security negotiation process may be included in discovery and relay selection processes.

The security manner in embodiments of this application may include one or more of the following: executing a security establishment procedure on a per-hop communication link between the source UE and the target UE; or executing a security establishment procedure on the end-to-end communication link between the source UE and the target UE. The per-hop communication link between the source UE and the target UE may include a per-hop communication link between the source UE and the relay UE and/or a per-hop communication link between the relay UE and the target UE.

A manner of carrying a negotiation result of the security manner is not specifically limited in embodiments of this application, provided that the negotiation result of the security manner is obtained before establishment of the end-to-end communication link. For example, the negotiation result of the security manner may be carried in one or more of the following: a direct communication request message; a direct communication accept message, a relay service code; or security data required for securely establishing the end-to-end communication link.

The relay service code (RSC) in embodiments of this application may be understood as an identifier, or may be a temporary authorization code, such as a token or a key. In another scenario, another name may be used, which is not limited in embodiments of this application. The relay service code may correspond to an identifier of an application. One relay service code may correspond to an identifier of one or more applications. In embodiments of this application, the negotiation result of the security manner may be carried in the RSC.

The security data required for securely establishing the end-to-end communication link may also be referred to as an end-to-end security material and may be represented by E2E_sec_Info. The E2E_sec_Info may include security capabilities of the source UE and a security policy of the source UE. In embodiments of this application, the negotiation result of the security manner may be carried in E2E_sec_Info.

In some embodiments, the negotiation result of the security manner may be carried in the first direct communication request message described above or may be carried in the second direct communication request message described above.

In some embodiments, the negotiation result of the security manner may be carried in the first direct communication accept message described above or may be carried in the second direct communication accept message described above.

Certainly, in some embodiments, the negotiation result of the security manner may alternatively be carried in messages in the discovery and relay selection processes.

In some embodiments, security protection of the end-to-end communication link may be performed at a PDCP layer. This manner is the same as a security protection manner of an existing PC5 unicast link, and changes to the protocol are relatively small. In some other embodiments, security protection of the end-to-end communication link may be performed at an adaptation layer. An adaptation layer is disposed for each of the source UE, the target UE, and the relay UE. Referring to protocol stacks shown in FIG. 6 and FIG. 7, the relay UE is connected to the source UE and the target UE by using the adaptation layer. Therefore, security protection is performed on the end-to-end communication link by using the adaptation layer. The adaptation layer may carry one or more of an end-to-end PC5 signal (PC5-S) message, PC5 radio resource control (PC5-RRC) signaling, or PC5-U data.

The following describes solutions in embodiments of this application in detail with reference to FIG. 10 to FIG. 13.

FIG. 10 shows a schematic flowchart of a process of establishing a shared key of an end-to-end communication link between a source UE and a target UE. In this process, there is no shared key K_{D} between the source UE and the target UE. The source UE is required to exchange authentication signaling with the target UE to generate the shared key K_{D} by using a security credential.

As shown in FIG. 10, in step S1002, a source UE, the relay UE, and the target UE execute discovery and relay selection processes.

In the discovery process, keys in the discovery process are separately established between the source UE and the relay UE, and between the relay UE and the target UE, to protect an announcement message, a solicitation message, and a DCR message in the discovery process.

In step S1004, the source UE transmits a first DCR message to the relay UE. The first DCR message may include one or more of the following information: an RSC, an E2E security indication, an end-to-end key establishment material Key_Est_Info, or a security material for establishing a per-hop security link between the source UE and the relay UE. The Key_Est_Info may include security capabilities of the source UE and a security policy of the source UE.

In some embodiments, the first DCR message may include an E2E security indication and/or a security credential ID. In some embodiments, the E2E security indication and/or security credential identity may be carried in E2E_sec_Info or Key_Est_Info or the RSC. The E2E security indication may be used to indicate whether to establish per-hop link security and/or whether to establish end-to-end security (that is, E2E security).

In some embodiments, the first DRC message may be allowed not to carry the E2E security indication. For example, if the source UE has not yet negotiated an E2E security manner with the target UE when transmitting the first DCR message, the first DCR message may not carry the E2E security indication.

In some embodiments, if there is no key K_{D} between the source UE and the target UE, or the source UE expects to update the key K_{D}, the first DCR message may include the security credential identity. If there is a key K_{D} between the source UE and the target UE, and the source UE does not expect to update the key K_{D}, the first DCR message may not include the security credential identity.

A security credential in embodiments of this application may be one or more of a symmetric key, a public-private key pair, or a password.

If the security credential is a symmetric key, the key may be generated by a network device in the discovery process and then transmitted by the network device to the source UE and the relay UE. The network device may be, for example, one or more of 5G ProSe Key Management Function (PKMF), 5G Direct Discovery Name Management Function (DDNMF), or authentication service function (AUSF). The first DCR (Key_Est_Info or E2E_sec_Info in the first DCR) message may include an identity of the key.

If the security credential is a public-private key pair, the first DCR (Key_Est_Info or E2E_sec_Info in the first DCR) message may include a public key of the source UE.

In step S1006, the source UE and the relay UE execute a first authentication and key establishment procedure. For example, the relay UE may transmit a first authentication and key establishment message to the source UE, and the source UE may transmit a first authentication and key establishment response message to the relay UE. The first authentication and key establishment message and the first authentication and key establishment response message may include Key_Est_Info.

In step S1008, the relay UE transmits a first security mode command message to the source UE.

In step S1010, the source UE transmits a first security mode command complete message to the relay UE.

In step S1012, the relay UE transmits a second DCR message to the target UE. The second DCR message may include one or more of the following: a security material for establishing a per-hop security link between the relay UE and the target UE, or an end-to-end key establishment material Key_Est_Info.

In some embodiments, content included in the second DCR message is substantially the same as content included in the first DCR message.

The relay UE generally does not modify Key_Est_Info received from the source UE. The relay UE may change a header including a data packet Key_Est_Info, for example, the relay UE may change a source L2 ID to a relay UE L2 ID and change a destination L2 ID to a target UE L2 ID.

In step S1014, the relay UE and the target UE execute a second authentication and key establishment procedure. For example, the target UE may transmit a second authentication and key establishment message to the relay UE, and the relay UE may transmit a second authentication and key establishment response message to the target UE. The second authentication and key establishment message and the first authentication and key establishment response message may include Key_Est_Info.

In step S1016, the target UE transmits a second security mode command message to the relay UE.

In step S1018, the relay UE transmits a second security mode command complete message to the target UE.

In step S1020, the target UE transmits a second DCA message to the relay UE, where establishment of a PC5 communication link between the target UE and the relay UE is completed.

In some embodiments, the second DCA message may include one or more of the following information: an E2E security indication, or Key_Est_Info. The Key_Est_Info may be Key_Est_Info from the target UE. The Key_Est_Info may include security capabilities of the source UE and/or a security policy of the source UE. In some embodiments, the E2E security indication may alternatively be carried in the Key_Est_Info.

In step S1022, the relay UE transmits a first DCA message to the source UE, where establishment of a PC5 communication link between the relay UE and the source UE is completed. In some embodiments, the first DCA message may include Key_Est_Info from the relay UE.

In some embodiments, the second DCA message may include one or more of the following information: an E2E security indication, or Key_Est_Info. The Key_Est_Info may be Key_Est_Info from the relay UE. The Key_Est_Info may include security capabilities of the source UE and/or a security policy of the source UE. In some embodiments, the E2E security indication may alternatively be carried in the Key_Est_Info.

In step S1024, after establishment of the communication links between the source UE and the relay UE, and between the relay UE and the target UE is completed, the source UE and the target UE may execute an authentication and key establishment procedure. For example, the source UE may transmit an authentication and key establishment message to the target UE, and the target UE transmits an authentication and key establishment response message to the source UE.

In some embodiments, the authentication and key establishment message may include Key_Est_Info. In some embodiments, the authentication and key establishment message may include an E2E security indication. For example, if the E2E security indication is not carried in the first DCR message, the authentication and key establishment message may include the E2E security indication.

In some embodiments, after the authentication and key establishment procedure ends, the source UE and the target UE may generate a key K_{D}.

In step S1026, the target UE transmits a third security mode command message to the source UE by using the relay UE. The third security mode command message may be referred to as a direct security mode command. In some embodiments, considering that the message needs to be transmitted by using the relay UE, the third security mode command message may also be referred to as an indirect security mode command.

In some embodiments, the third security mode command message may include Key_Est_Info. In some embodiments, the Key_Est_Info may include an MSB of a K_{D} ID. In some embodiments, if a key K_{D} is not generated by the source UE and the target UE in step S1024, the Key_Est_Info may include another E2E security parameter for generating the K_{D}.

In step S1028, the source UE may transmit a third security mode command complete message to the target UE by using the relay UE.

In some embodiments, the source UE may select an LSB of the K_{D} ID. The third security mode command completion message includes the LSB of the K_{D} ID.

In some embodiments, if no K_{D} is generated in step S1024, the source UE may generate K_{D} based on the another E2E security parameter.

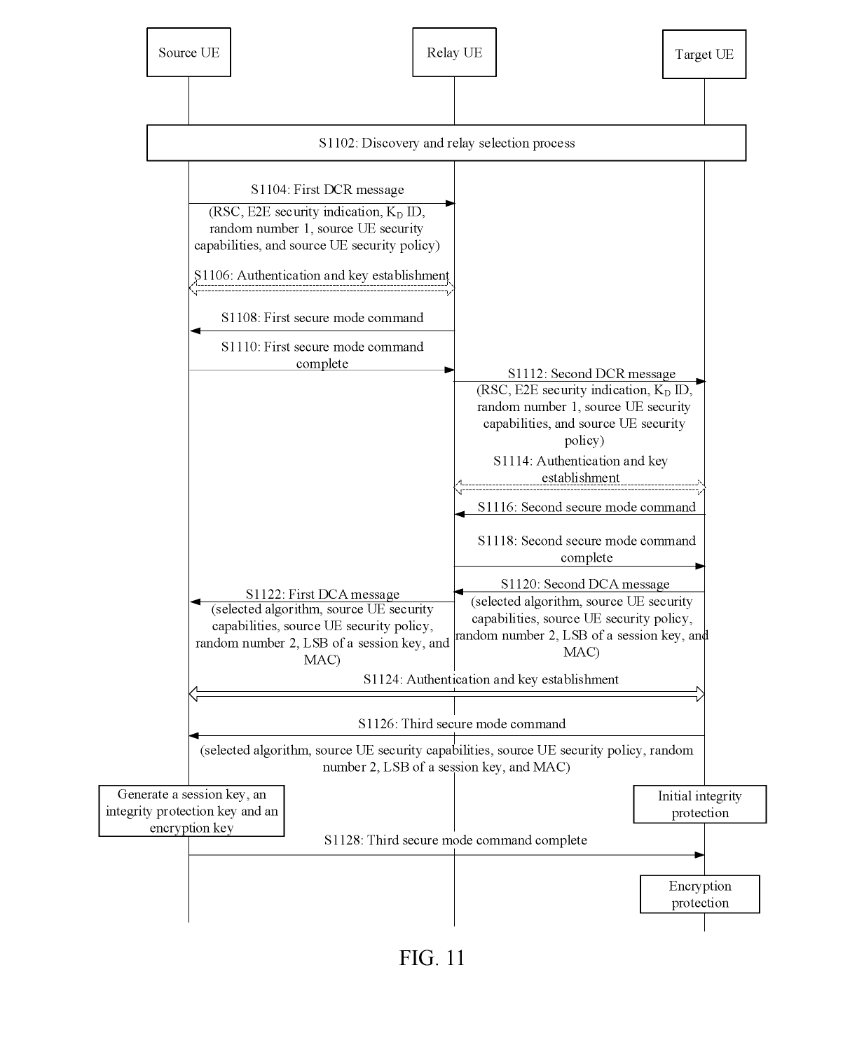

With reference to FIG. 11, the following describes an E2E connection and security establishment process in embodiments of this application.

In this process, there is already a shared key K_{D} and a K_{D} ID between a source UE and a target UE.

Referring to FIG. 11, in step S1102, the source UE, a relay UE, and the target UE execute a discovery and relay selection process. This process is similar to step S1002 in FIG. 10.

In the discovery process, keys in the discovery process are separately established between the source UE and the relay UE, and between the relay UE and the target UE, to protect an announcement message, a solicitation message, and a DCR message in the discovery process.

In step S1104, the source UE transmits a first DCR message to the relay UE. The first DCR message may include one or more of the following information: an RSC, an end-to-end security material E2E_sec_Info, and a security material for establishing a per-hop security link between the source UE and the relay UE. The E2E_sec_Info may include security capabilities of the source UE and a security policy of the source UE.

In some embodiments, the first DCR message may include an E2E security indication. The E2E security indication may be used to indicate a secure connection manner between the source UE and the target UE. In some embodiments, the E2E security indication may be carried in Key_Est_Info or E2E_sec_Info or the RSC.

In some embodiments, the first DRC message may be allowed not to carry the E2E security indication. For example, if the source UE has not yet negotiated an E2E security manner when transmitting the first DCR message, the first DCR message may not carry the E2E security indication. The E2E security indication may indicate that E2E security needs to be established.

In some embodiments, if there has been a key K_{D} between the source UE and the target UE, the first DCR message may include one or more of the following information: a K_{D} ID, nonce 1, or an MSB of K_{D-sess}. The nonce 1 may be used to generate or update K_{D-sess}.

The following steps S1106 to S1118 are similar to steps S1006 to S1018 in FIG. 10.

In step S1106, the source UE and the relay UE execute a first authentication and key establishment procedure. For example, the relay UE may transmit a first authentication and key establishment message to the source UE, and the source UE may transmit a first authentication and key establishment response message to the relay UE. The first authentication and key establishment message and the first authentication and key establishment response message may include Key_Est_Info.

In step S1108, the relay UE transmits a first security mode command message to the source UE.

In step S1110, the source UE transmits a first security mode command complete message to the relay UE.

In step S1112, the relay UE transmits a second DCR message to the target UE. The second DCR message may include one or more of the following: a security material for establishing a per-hop security link between the relay UE and the target UE, or an end-to-end security material E2E_sec_Info.

In some embodiments, content included in the second DCR message is substantially the same as content included in the first DCR message.

The relay UE generally does not modify Key_Est_Info received from the source UE. The relay UE may change a header including a data packet Key_Est_Info, for example, the relay UE may change a source L2 ID to a relay UE L2 ID and change a destination L2 ID to a target UE L2 ID.

In step S1114, the relay UE and the target UE execute a second authentication and key establishment procedure. For example, the target UE may transmit a second authentication and key establishment message to the relay UE, and the relay UE may transmit a second authentication and key establishment response message to the target UE. The second authentication and key establishment message and the first authentication and key establishment response message may include Key_Est_Info.

In step S1116, the target UE transmits a second security mode command message to the relay UE.

In step S1118, the relay UE transmits a second security mode command complete message to the target UE.

In step S1120, the target UE transmits a second DCA message to the relay UE, where establishment of a PC5 communication link between the target UE and the relay UE is completed.

In some embodiments, the second DCA message may include one or more of the following: a selected algorithm, security capabilities of the source UE, a security policy of the source UE, nonce 2, an LSB of the K_{D-sess}, or MAC.

In some embodiments, if the E2E security indication received by the target UE indicates that only per-hop link security is established, end-to-end security information (E2E_sec_Info) may be included in the second DCA message transmitted by the target UE to the relay UE.

In some embodiments, if the E2E security indication received by the target UE instructs to establish E2E security, the target UE may add E2E_sec_Info to the second DCA message or add E2E_sec_Info to the third security mode command in step S1126.

In some embodiments, the target UE may select a security algorithm (chosen_alg) based on the security capabilities of the source UE. The target UE may further determine, based on the security policy of the source UE, an E2E protection form, for example, whether integrity protection or encryption protection is used. The second DCA message may include the selected algorithm. To defend against bid attacks, the second DCA message may further include the security capabilities of the source UE and the security policy of the source UE.

In some embodiments, the source UE may select random number nonce 2 and generate the key K_{D-sess} based on the nonce 2. The target UE may further select an LSB of a K_{D-sess} ID. The target UE may further generate lower-level keys K_{D-int} and K_{D-enc} based on the security policy of the source UE, so as to respectively protect integrity and confidentiality of end-to-end data between the source UE and the target UE.

After the target UE is generated, integrity protection may be started on the E2E data, that is, a check value MAC of E2E_sec_Info may be calculated by using K_{D-int}.

In step S1122, the relay UE transmits a first DCA message to the source UE, where establishment of a PC5 communication link between the relay UE and the source UE is completed. The first DCA message may include E2E_sec_Info from the relay UE.

Content included in the first DCA message is substantially the same as content included in the second DCA message. In some embodiments, the first DCA message may include one or more of the following: the selected algorithm, the security capabilities of the source UE, the security policy of the source UE, nonce 2, the LSB of the K_{D-sess}, or the MAC.

In step S1124, after establishment of the communication links between the source UE and the relay UE, and between the relay UE and the target UE is completed, the source UE and the target UE may execute an authentication and key establishment procedure. For example, the source UE may transmit an authentication and key establishment message to the target UE, and the target UE transmits an authentication and key establishment response message to the source UE.

In some embodiments, the source UE and the target UE may not perform the procedure in step S1124.

In step S1126, the target UE transmits a third security mode command message to the source UE by using the relay UE. The third security mode command message may be referred to as a direct security mode command. In some embodiments, considering that the message needs to be transmitted by using the relay UE, the third security mode command message may also be referred to as an indirect security mode command.

In some embodiments, the third security mode command message may include E2E_sec_Info. The third security mode command message may include one or more of the following: the selected algorithm, the security capabilities of the source UE, the security policy of the source UE, the nonce 2, the LSB of the K_{D-sess}, or the MAC.

In step S1128, the source UE may transmit a third security mode command complete message to the target UE by using the relay UE.

In some embodiments, the source UE may generate K_{D-sess}, K_{D-int}, and K_{D-enc}. In addition, the source UE may further check the MAC by using K_{D-int}. After the check succeeds, the source UE may start, based on the security policy, encryption protection and integrity protection on the E2E data.

After receiving the third security mode command complete message, the target UE may start to perform encryption protection and integrity protection on the E2E data based on the security policy.

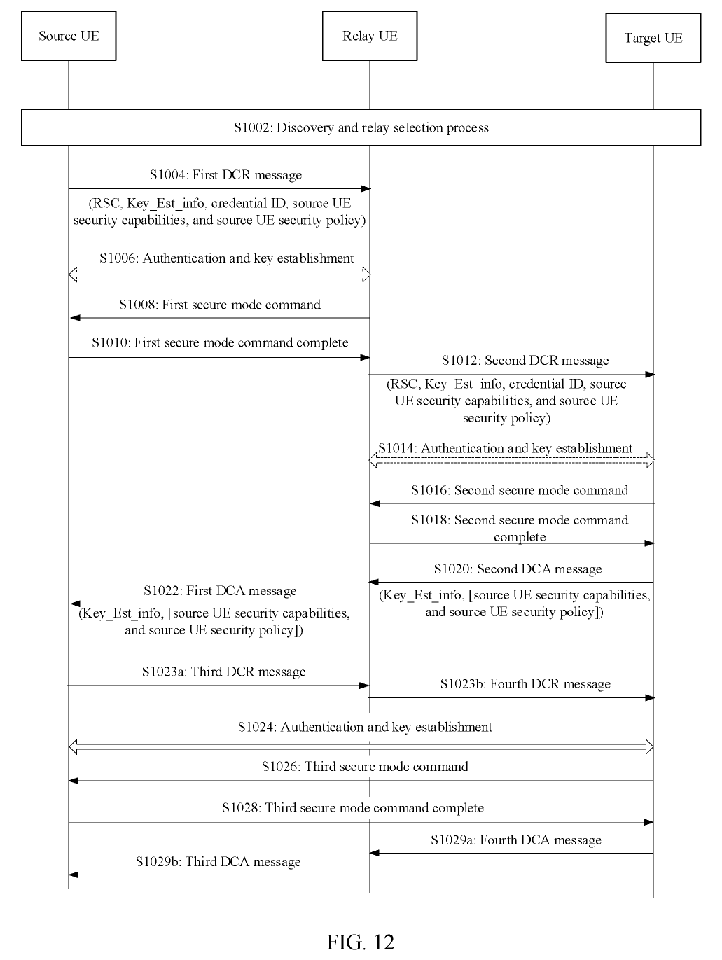

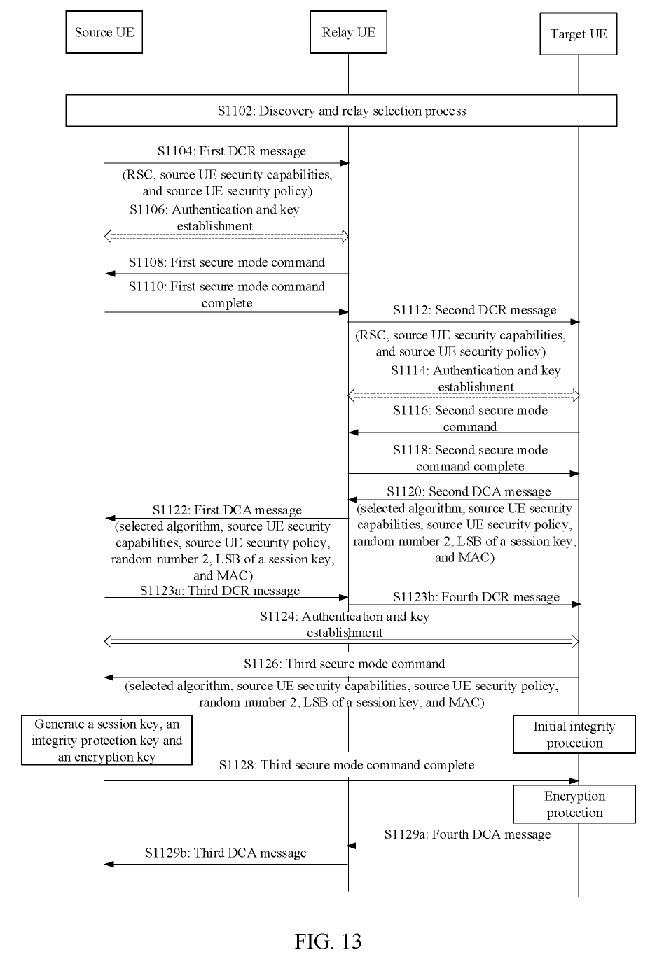

FIG. 10 and FIG. 11 show that the source UE and the target UE may directly perform an authentication and/or key establishment procedure or a security mode command procedure after the communication links between the source UE and the relay UE, and between the relay UE and the target UE are established. In some embodiments, after the communication links between the source UE and the relay UE, and between the relay UE and the target UE are established, a DCR message may alternatively be transmitted between the source UE and the target UE, and then the authentication and/or key establishment procedure or the security mode command procedure is performed, as shown in FIG. 12 and FIG. 13.

FIG. 12 shows another flowchart for establishing the shared key K_{D}. Step procedures in FIG. 12 are similar to the step procedures in FIG. 10, and differences lie in that step S1023a, step S1023b, step S1029a, and step S1029b are added in FIG. 12, and step S1004, step S1012, step S1020, and step S1022 in FIG. 12 are slightly different from corresponding steps in FIG. 10. To simplify the description, the following describes these differences only. For other content, reference may be made to the foregoing description.

In the solution illustrated in FIG. 12, a first DCR message in step S1004 may include only information required for establishing a per-hop communication link between a source UE and a relay UE, and not include information required for establishing an end-to-end link between the source UE and a target UE. For example, the first DCR message may include one or more of the following information: an RSC, an E2E security indication, or a security material for establishing a per-hop security link between the source UE and the relay UE. The E2E security indication may be used only to indicate whether to establish per-hop link security instead of indicating whether to establish end-to-end security.

In some embodiments, the E2E security indication may not be included in the first DCR message.

In some embodiments, an end-to-end key establishment material Key_Est_Info may not be included in the first DCR message.

The second DCR message in step S1012 may also include only information required for establishing a per-hop communication link between the source UE and the relay UE, and not include information required for establishing an end-to-end link between the source UE and the target UE. For example, the second DCR message may include one or more of the following information: an RSC, an E2E security indication, or a security material for establishing a per-hop security link between the source UE and the relay UE. The E2E security indication may be used only to indicate whether to establish per-hop link security instead of indicating whether to establish end-to-end security.

In some embodiments, the E2E security indication may not be included in the second DCR message.

In some embodiments, an end-to-end key establishment material Key_Est_Info may not be included in the second DCR message.

In some embodiments, content in the first DCR message may be the same as content in the second DCR message.

The second DCA message in step S1020 may also include only information required for establishing a per-hop communication link between the source UE and the relay UE, and not include information required for establishing an end-to-end link between the source UE and the target UE. For example, the second DCA message may include one or more of the following information: an E2E security indication, or a security material for establishing a per-hop security link between the source UE and the relay UE. The E2E security indication may be used only to indicate whether to establish per-hop link security instead of indicating whether to establish end-to-end security.

In some embodiments, the E2E security indication may not be included in the second DCA message.

The first DCA message in step S1022 may also include only information required for establishing a per-hop communication link between the source UE and the relay UE, and not include information required for establishing an end-to-end link between the source UE and the target UE. For example, the first DCA message may include one or more of the following information: an E2E security indication, or a security material for establishing a per-hop security link between the source UE and the relay UE. The E2E security indication may be used only to indicate whether to establish per-hop link security instead of indicating whether to establish end-to-end security.

In some embodiments, the E2E security indication may not be included in the first DCA message.

In some embodiments, content in the first DCA message may be the same as content in the second DCA message.

In step S1023a, the source UE transmits a third DCR message to the relay UE. The third DCR message may include data required for establishing an end-to-end communication link. For example, the third DCR message may include one or more of the following information: an RSC, an E2E security indication, or an end-to-end key establishment material Key_Est_Info. The Key_Est_Info may include security capabilities of the source UE and a security policy of the source UE. The E2E security indication may be used to indicate whether to establish end-to-end security.

In some embodiments, the third DCR message may further include one or more of the following information: an RSC, a user information ID of the source UE (User Info ID of Source UE), a user information ID of the relay UE (User Info ID of UE-to-UE relay), a user information ID of the target UE (User Info ID of Target UE), or an L2 ID.

In step S1023b, the relay UE transmits a fourth DCR message to the target UE. The fourth DCR message may include data required for establishing an end-to-end communication link. For example, content included in the fourth DCR message may be the same with content included in the third DCR message. For example, the fourth DCR message may include one or more of the following information: an RSC, an E2E security indication, or an end-to-end key establishment material Key_Est_Info. The Key_Est_Info may include security capabilities of the source UE and a security policy of the source UE. The E2E security indication may be used to indicate whether to establish end-to-end security.

In some embodiments, the third DCR message may further include one or more of the following information: an RSC, a user information ID of the source UE (User Info ID of Source UE), a user information ID of the relay UE (User Info ID of UE-to-UE relay), a user information ID of the target UE (User Info ID of Target UE), or an L2 ID.

In step S1029a, the target UE transmits a fourth DCA message to the relay UE. The fourth DCA message may include data required for establishing an end-to-end communication link. For example, the fourth DCA message may include one or more of the following information: an E2E security indication, or an end-to-end key establishment material Key_Est_Info. The E2E security indication may be used to indicate whether to establish end-to-end security.

In some embodiments, the fourth DCR message may further include one or more of the following information: an RSC, a user information ID of the source UE (User Info ID of Source UE), a user information ID of the relay UE (User Info ID of UE-to-UE relay), a user information ID of the target UE (User Info ID of Target UE), or an L2 ID.

In step S1029b, the relay UE transmits a third DCA message to the source UE. The third DCA message may include data required for establishing an end-to-end communication link, such as security data required for securely establishing the end-to-end communication link. For example, the third DCA message may include one or more of the following information: an E2E security indication, or an end-to-end key establishment material Key_Est_Info. The E2E security indication may be used to indicate whether to establish end-to-end security.

FIG. 13 shows another schematic flowchart for establishing a secure connection. Step procedures in FIG. 13 are similar to the step procedures in FIG. 11, and differences lie in that step S1123a, step S1123b, step S1129a, and step S1129b are added in FIG. 13, and step S1104, step S1112, step S1120, and step S1122 in FIG. 13 are slightly different from corresponding steps in FIG. 11. To simplify the description, the following describes these differences only. For other content, reference may be made to the foregoing description.

In the solution illustrated in FIG. 13, a first DCR message in step S1104 may include only information required for establishing a per-hop communication link between a source UE and a relay UE, and not include information required for establishing an end-to-end link between the source UE and a target UE. For example, the first DCR message may include one or more of the following information: an RSC, an E2E security indication, or a security material for establishing a per-hop security link between the source UE and the relay UE. The E2E security indication may be used only to indicate whether to establish per-hop link security instead of indicating whether to establish end-to-end security.

In some embodiments, the E2E security indication may not be included in the first DCR message.

In some embodiments, an end-to-end key establishment material Key_Est_Info may not be included in the first DCR message.

The second DCR message in step S1112 may also include only information required for establishing a per-hop communication link between the source UE and the relay UE, and not include information required for establishing an end-to-end link between the source UE and the target UE. For example, the second DCR message may include one or more of the following information: an RSC, an E2E security indication, or a security material for establishing a per-hop security link between the source UE and the relay UE. The E2E security indication may be used only to indicate whether to establish per-hop link security instead of indicating whether to establish end-to-end security.

In some embodiments, the E2E security indication may not be included in the second DCR message.

In some embodiments, an end-to-end key establishment material Key_Est_Info may not be included in the second DCR message.

In some embodiments, the first DCR message and/or the second DCR message may not include one or more of the following information: a K_{D} ID, nonce 1, or an MSB of K_{D-sess}. For example, the E2E_sec_Info in the first DCR message and/or the second DCR message may not include one or more of the following information: the K_{D} ID, the nonce 1, or the MSB of K_{D-sess}.

In some embodiments, content in the first DCR message may be the same as content in the second DCR message.

The second DCA message in step S1120 may include only information required for establishing a per-hop communication link between the source UE and the relay UE, and not include information required for establishing an end-to-end link between the source UE and the target UE. For example, the second DCA message may include one or more of the following information: an E2E security indication, or a security material for establishing a per-hop security link between the source UE and the relay UE. The E2E security indication may be used only to indicate whether to establish per-hop link security instead of indicating whether to establish end-to-end security.

In some embodiments, the E2E security indication may not be included in the second DCA message.

The first DCA message in step S1122 may include only information required for establishing a per-hop communication link between the source UE and the relay UE, and not include information required for establishing an end-to-end link between the source UE and the target UE. For example, the first DCA message may include one or more of the following information: an E2E security indication, or a security material for establishing a per-hop security link between the source UE and the relay UE. The E2E security indication is used only to indicate whether to establish per-hop link security instead of indicating whether to establish end-to-end security.

In some embodiments, the E2E security indication may not be included in the first DCA message.

In step S1123a, the source UE transmits a third DCR message to the relay UE. The third DCR message may include data required for establishing an end-to-end communication link. For example, the third DCR message may include one or more of the following information: an RSC, an E2E security indication, or an end-to-end security material E2E_sec_Info. The E2E_sec_Info may include security capabilities of the source UE and a security policy of the source UE. The E2E security indication may be used to indicate whether to establish end-to-end security.

In some embodiments, the third DCR message may include one or more of the following information: a K_{D} ID, nonce 1, or an MSB of K_{D-sess}. For example, the E2E_sec_Info in the third DCR message may include one or more of the following information: the K_{D} ID, the nonce 1, or the MSB of K_{D-sess}.

In some embodiments, the third DCR message may further include one or more of the following information: an RSC, a user information ID of the source UE (User Info ID of Source UE), a user information ID of the relay UE (User Info ID of UE-to-UE relay), a user information ID of the target UE (User Info ID of Target UE), or an L2 ID.

In step S1123b, the relay UE transmits a fourth DCR message to the target UE. The fourth DCR message may include data required for establishing an end-to-end communication link. For example, content included in the fourth DCR message may be the same with content included in the third DCR message. For example, the fourth DCR message may include one or more of the following information: an RSC, an E2E security indication, or E2E_sec_Info. The Key_Est_Info may include security capabilities of the source UE and a security policy of the source UE. The E2E security indication may be used to indicate whether to establish end-to-end security.

In some embodiments, the fourth DCR message may include one or more of the following information: a K_{D} ID, nonce 1, or an MSB of K_{D-sess}. For example, the E2E_sec_Info in the fourth DCR message may include one or more of the following information: the K_{D} ID, the nonce 1, or the MSB of K_{D-sess}.

In some embodiments, the fourth DCR message may further include one or more of the following information: an RSC, a user information ID of the source UE (User Info ID of Source UE), a user information ID of the relay UE (User Info ID of UE-to-UE relay), a user information ID of the target UE (User Info ID of Target UE), or an L2 ID.

In step S1129a, the target UE transmits a fourth DCA message to the relay UE. The fourth DCA message may include data required for establishing an end-to-end communication link. For example, the fourth DCA message may include one or more of the following information: an E2E security indication, or an end-to-end security material. The E2E security indication may be used to indicate whether to establish end-to-end security.

In step S1129b, the relay UE transmits a third DCA message to the source UE. The third DCA message may include data required for establishing an end-to-end communication link. For example, the third DCA message may include one or more of the following information: an E2E security indication, or an end-to-end security material. The E2E security indication may be used to indicate whether to establish end-to-end security.

In embodiments of this application, establishment procedures of the per-hop link and the end-to-end link may not be performed under network coverage, that is, core network assistance is not required.

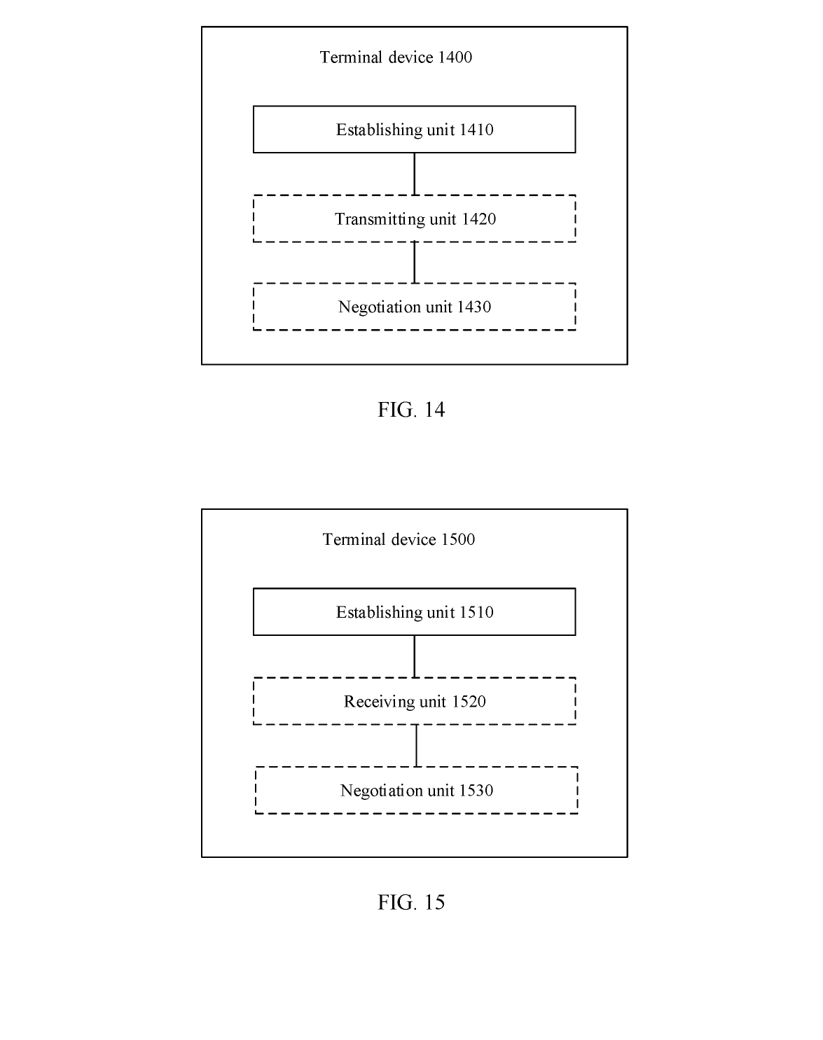

The method embodiments of this application are described above in detail with reference to FIG. 1 to FIG. 13. Apparatus embodiments of this application are described below in detail with reference to FIG. 14 to FIG. 17. It should be understood that the descriptions of the method embodiments correspond to descriptions of the apparatus embodiments, and therefore, for parts that are not described in detail, reference may be made to the foregoing method embodiments.

FIG. 14 is a schematic block diagram of a terminal device according to an embodiment of this application. The terminal device may be the source UE or the UE 1 described above. The terminal device 1400 may include an establishment unit 1410.

The establishing unit 1410 is configured to establish a communication link with a relay UE.

The establishing unit 1410 is further configured to establish an end-to-end communication link with a target UE after the relay UE establishes a communication link with each of the source UE and the target UE.

Optionally, in some embodiments, the communication link between the source UE and the relay UE is a securely established communication link; and/or the communication link between the relay UE and the target UE is a securely established communication link.

Optionally, in some embodiments, the securely establishing, by the source UE, the end-to-end communication link with the target UE includes one or more of the following: establishing, by the source UE, a shared key of the end-to-end communication link with the target UE; establishing, by the source UE, a session key of the end-to-end communication link with the target UE; establishing, by the source UE, an integrity protection key of the end-to-end communication link with the target UE; or establishing, by the source UE, an encryption key of the end-to-end communication link with the target UE.

Optionally, in some embodiments, the establishing unit 1410 is configured to trigger the relay UE to establish a communication link with each of the source UE and the target UE.

Optionally, in some embodiments, the establishing unit 1410 is configured to: transmit a first direct communication request message to the relay UE, where the first direct communication request message is used to trigger the relay UE to establish the communication link with the source UE; execute a first security mode command procedure with the relay UE; and after the first security mode command procedure and the second security mode command procedure between the relay UE and the target UE are completed, receive a first direct communication accept message transmitted by the relay UE for the first direct communication request message.

Optionally, in some embodiments, the establishing unit 1410 is configured to execute a third security mode command procedure with the target UE.

Optionally, in some embodiments, the terminal device further includes a transmitting unit 1420, configured to transmit a third direct communication request to the relay UE, where the third direct communication request is used to trigger the relay UE to transmit a fourth direct communication request to the target UE, and the fourth direct communication request is used to trigger the target UE to securely establish the end-to-end communication link with the source UE.

Optionally, in some embodiments, at least one of the third direct communication request or the fourth direct communication request includes one or more of the following information: information for instructing securely establishing the end-to-end communication link; or security data required for securely establishing the end-to-end communication link.

Optionally, in some embodiments, the terminal device 1400 further includes a negotiation unit 1430, configured to negotiate a security manner with the target UE, where the security manner includes one or more of the following: executing a security establishment process on a per-hop communication link between the source UE and the target UE; or executing a security establishment process on the end-to-end communication link between the source UE and the target UE.

Optionally, in some embodiments, a negotiation result of the security manner is carried in one or more of the following: a direct communication request message; a direct communication accept message, a relay service code; or security data required for securely establishing the end-to-end communication link.

Optionally, in some embodiments, security protection of the end-to-end communication link is performed in a packet data convergence protocol PDCP layer or an adaptation layer.

FIG. 15 is a schematic block diagram of another terminal device according to an embodiment of this application. The terminal device may be any target UE or UE 2 described above. The terminal device 1500 may include an establishment unit 1510.

The establishing unit 1510 is configured to establish a communication link with a relay UE.

The establishing unit 1510 is further configured to establish an end-to-end communication link with a source UE after the relay UE establishes a communication link with each of the source UE and the target UE.

Optionally, in some embodiments, the communication link between the source UE and the relay UE is a securely established communication link; and/or the communication link between the relay UE and the target UE is a securely established communication link.

Optionally, in some embodiments, the establishing, by the target UE, the communication link with the relay UE includes one or more of the following: establishing, by the target UE, a shared key of the end-to-end communication link with the source UE; establishing, by the target UE, a session key of the end-to-end communication link with the source UE; establishing, by the source UE, an integrity protection key of the end-to-end communication link with the target UE; or establishing, by the source UE, an encryption key of the end-to-end communication link with the target UE.

Optionally, in some embodiments, the establishing unit 1510 is configured to establish the communication link with the relay UE under trigger of the source UE.

Optionally, in some embodiments, the establishing unit 1510 is configured to: after execution of a first security mode command procedure between the source UE and the relay UE ends, receive a second direct communication request message transmitted by the relay UE, where the second direct communication request message is used to trigger the target UE to establish the communication link with the relay UE; in response to the second direct communication request message, execute a second security mode command procedure with the relay UE; and in response to completion of the second security mode command procedure, transmit a second direct communication accept message for the second direct communication request message to the relay UE.

Optionally, in some embodiments, the establishing unit 1510 is configured to execute a third security mode command procedure with the source UE.

Optionally, in some embodiments, the terminal device further includes a receiving unit 1520, configured to receive a fourth direct communication request transmitted by the relay UE after the relay UE receives a third direct communication request transmitted by the source UE, where the fourth direct communication request is used to trigger the target UE to securely establish the end-to-end communication link with the source UE.

Optionally, in some embodiments, at least one of the third direct communication request or the fourth direct communication request includes one or more of the following information: information for instructing securely establishing the end-to-end communication link; or security data required for securely establishing the end-to-end communication link.

Optionally, in some embodiments, the terminal device 1500 further includes a negotiation unit 1530, configured to negotiate a security manner with the source UE, where the security manner includes one or more of the following: executing a security establishment process on a per-hop communication link between the source UE and the target UE; or executing a security establishment process on the end-to-end communication link between the source UE and the target UE.

Optionally, in some embodiments, a negotiation result of the security manner is carried in one or more of the following: a direct communication request message; a direct communication accept message, a relay service code; or security data required for securely establishing the end-to-end communication link.

Optionally, in some embodiments, security protection of the end-to-end communication link is performed in a packet data convergence protocol PDCP layer or an adaptation layer.

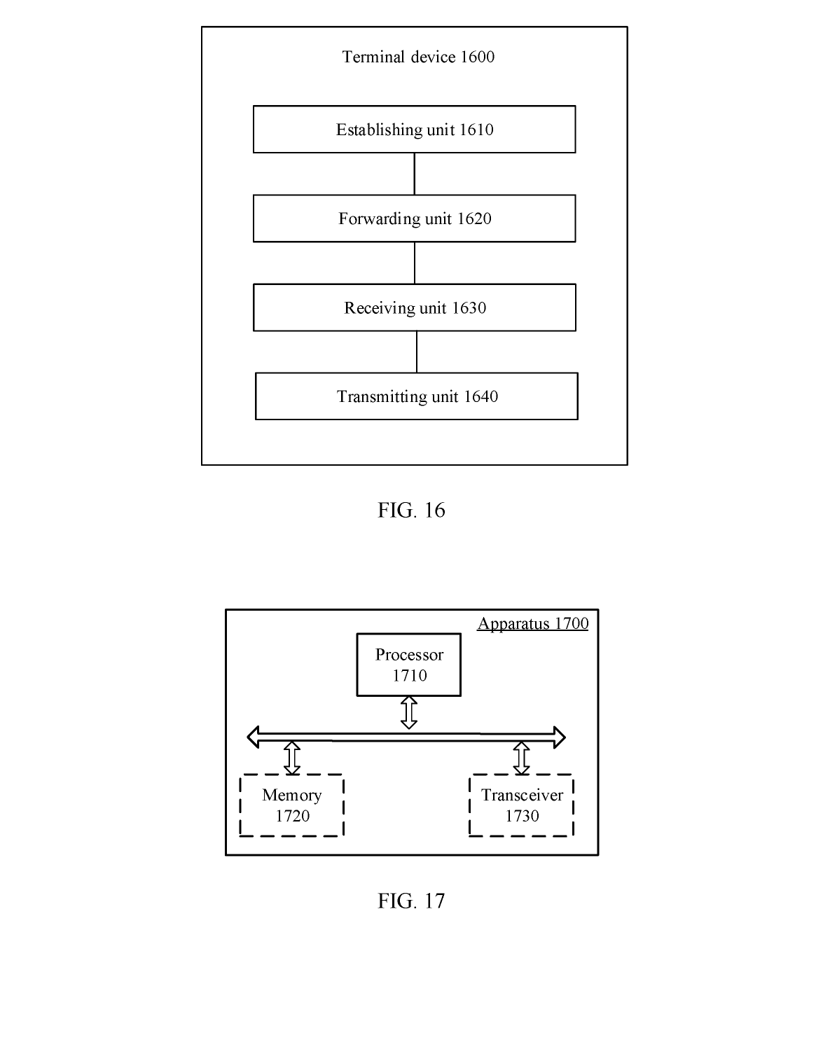

FIG. 16 is a schematic block diagram of another terminal device according to an embodiment of this application. The terminal device may be any relay UE described above. The terminal device 1600 may include an establishing unit 1610 and a forwarding unit 1620.

The establishing unit 1610 is configured to establish a communication link with each of a source UE and a target UE.

The forwarding unit 1620 is configured to forward an end-to-end message between the source UE and the target UE after the relay UE establishes the communication link with each of the source UE and the target UE, where the end-to-end message is used by the source UE to securely establish an end-to-end communication link with the target UE.

Optionally, in some embodiments, the communication link between the source UE and the relay UE is a securely established communication link; and/or the communication link between the relay UE and the target UE is a securely established communication link.

Optionally, in some embodiments, the securely establishing, by the source UE, the end-to-end communication link with the target UE includes one or more of the following: establishing, by the source UE, a shared key of the end-to-end communication link with the target UE; establishing, by the source UE, a session key of the end-to-end communication link with the target UE; establishing, by the source UE, an integrity protection key of the end-to-end communication link with the target UE; or establishing, by the source UE, an encryption key of the end-to-end communication link with the target UE.

Optionally, in some embodiments, the establishing unit 1610 is configured to establish the communication link with each of the source UE and the target UE under trigger of the source UE.

Optionally, in some embodiments, the establishing unit 1610 is configured to: receive a first direct communication request message transmitted by the source UE, where the first direct communication request message is used to trigger the relay UE to establish the communication link with the source UE; execute a first security mode command procedure with the source UE; transmit a second direct communication request message to the target UE after the first security mode command procedure is completed, where the second direct communication request message is used to trigger the target UE to establish a communication link with the relay UE; execute a second security mode command procedure with the target UE; receive a second direct communication accept message for the second direct communication request message from the target UE after the second security mode command procedure is completed; and transmit a first direct communication accept message for the first direct communication request message to the source UE in response to the second direct communication accept message.

Optionally, in some embodiments, the securely establishing, by the source UE, the end-to-end communication link with the target UE includes: executing, by the source UE, a third security mode command procedure with the target UE.

Optionally, in some embodiments, the terminal device further includes a receiving unit 1630, configured to receive a third direct communication request transmitted by the source UE before the source UE executes the third security mode command procedure with the target UE; and a transmitting unit 1640, configured to transmit a fourth direct communication request to the target UE in response to the third direct communication request, where the fourth direct communication request is used to trigger the target UE to securely establish the end-to-end communication link with the source UE.

Optionally, in some embodiments, at least one of the third direct communication request or the fourth direct communication request includes one or more of the following information: information for instructing securely establishing the end-to-end communication link; or

security data required for securely establishing the end-to-end communication link.

Optionally, in some embodiments, the end-to-end communication link is established based on a security manner negotiated by the source UE and the target UE, and the security manner includes one or more of the following: executing a security establishment process on a per-hop communication link between the source UE and the target UE; or executing a security establishment process on the end-to-end communication link between the source UE and the target UE.

Optionally, in some embodiments, a negotiation result of the security manner is carried in one or more of the following: a direct communication request message; a direct communication accept message, a relay service code; or security data required for securely establishing the end-to-end communication link.

Optionally, in some embodiments, security protection of the end-to-end communication link is performed in a PDCP layer or an adaptation layer.

FIG. 17 is a schematic diagram of a structure of a communications apparatus according to an embodiment of this application. Dashed lines in FIG. 17 indicate that a unit or module is optional. The apparatus 1700 may be configured to implement the methods described in the foregoing method embodiments. The apparatus 1700 may be a chip or a terminal device, such as the source UE, the relay UE, or the target UE described above.

The apparatus 1700 may include one or more processors 1710. The processor 1710 may support the apparatus 1700 in implementing the methods described in the foregoing method embodiments. The processor 1710 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The apparatus 1700 may further include one or more memories 1720. The memory 1720 stores a program, where the program may be executed by the processor 1710, to cause the processor 1710 to execute the methods described in the method embodiments. The memory 1720 may be separated from or integrated into the processor 1710.

The apparatus 1700 may further include a transceiver 1730. The processor 1710 may communicate with another device or chip by using the transceiver 1730. For example, the processor 1710 may transmit data to and receive data from another device or chip through the transceiver 1730.

An embodiment of this application further provides a computer-readable storage medium for storing a program. The computer-readable storage medium may be applied to a terminal or a network device provided in embodiments of this application, and the program causes a computer to execute the methods executed by the terminal or the network device in various embodiments of this application.

An embodiment of this application further provides a computer program product. The computer program product includes a program. The computer program product may be applied to a terminal or a network device provided in embodiments of this application, and the program causes a computer to execute the methods executed by the terminal or the network device in various embodiments of this application.

An embodiment of this application further provides a computer program. The computer program may be applied to a terminal or a network device provided in embodiments of this application, and the computer program causes a computer to execute the methods executed by the terminal or the network device in various embodiments of this application.

It should be understood that, in embodiments of this application, “B that is corresponding to A” means that B is associated with A, and B may be determined based on A. However, it should be further understood that, determining B based on A does not mean determining B based only on A, but instead, B may be determined based on A and/or other information.

It should be understood that, in this specification, the term “and/or” is merely an association relationship that describes associated objects and represents that there may be three relationships. For example, A and/or B may represent three cases: only A exists, both A and B exist, and only B exists. In addition, the character “/” in this specification generally indicates an “or” relationship between the associated objects.

It should be understood that, in embodiments of this application, sequence numbers of the foregoing processes do not mean execution sequences. The execution sequences of the processes should be determined based on functions and internal logic of the processes and should not be construed as any limitation on the implementation processes of the embodiments of this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method for secure establishment, comprising:
establishing, by a source user equipment (UE), a communication link with a relay UE; and after the relay UE establishes a communication link with each of the source UE and a target UE, securely establishing by the source UE an end-to-end communication link with the target UE.

2. The method according to claim 1, wherein
the communication link between the source UE and the relay UE is a securely established communication link, and/or
the communication link between the relay UE and the target UE is a securely established communication link.

3. The method according to claim 1, wherein the securely establishing, by the source UE, the end-to-end communication link with the target UE comprises one or more of following:
establishing, by the source UE, a shared key of the end-to-end communication link with the target UE;
establishing, by the source UE, a session key of the end-to-end communication link with the target UE;
establishing, by the source UE, an integrity protection key of the end-to-end communication link with the target UE; or
establishing by the source UE, an encryption key of the end-to-end communication link with the target UE.

4. The method according to claim 1, wherein the establishing by the source UE, the communication link with the relay UE comprises:
triggering, by the source UE, the relay UE to establish a communication link with each of the source UE and the target UE.

5. The method according to claim 4, wherein the triggering, by the source UE, the relay UE to establish the communication link with each of the source UE and the target UE comprises:
transmitting, the source UE, a first direct communication request message to the relay UE, wherein the first direct communication request message is used to trigger the relay UE to establish the communication link with the source UE;
executing, by the source UE and relay UE, a first security mode command procedure; and
after the first security mode command process and a second security mode command process between the relay UE and the target UE are completed, receiving by the source UE, a first direct communication accept message transmitted by the relay UE for the first direct communication request message.

6. The method according to claim 1, wherein the securely establishing, by the source UE, the end-to-end communication link with the target UE comprises:
executing, by the source UE, a third security mode command procedure with the target UE.

7. The method according to claim 6, wherein before the executing, by the source UE, the third security mode command procedure with the target UE, the method further comprises:
transmitting, by the source UE, a third direct communication request to the relay UE, wherein the third direct communication request is used to trigger the relay UE to transmit a fourth direct communication request to the target UE, and the fourth direct communication request is used to trigger the target UE to securely establish the end-to-end communication link with the source UE.

8. The method according to claim 7, wherein at least one of the third direct communication request or the fourth direct communication request comprises one or more of following information:
information for instructing securely establishing the end-to-end communication link; or
security data required for securely establishing the end-to-end communication link.

9. A communication method, comprising:
establishing, by a target user equipment UE, a communication link with a relay UE; and
after the relay UE establishes a communication link with each of the source UE and the target UE, securely establishing, by the target UE, an end-to-end communication link with the source UE.

10. The method according to claim 9, wherein
the communication link between the source UE and the relay UE is a securely established communication link; and/or
the communication link between the relay UE and the target UE is securely established communication link.

11. The method according to claim 9, wherein the establishing, by the target UE, the communication link with the relay UE comprises one or more of following:
establishing, by the target UE, a shared key of the end-to-end communication link with the source UE;
establishing, by the target UE, a session key of the end-to-end communication link with the source UE;
establishing, by the source UE, an integrity protection key of the end-to-end communication link with the target UE; or
establishing, by the source UE, an encryption key of the end-to-end communication link with the target UE.

12. The method according to claim 9, wherein the establishing by the target UE, the communication link with the relay UE comprises:
after execution of a first security mode command procedure between the source UE and the relay UE ends, receiving, by the target UE, a second direct communication request message transmitted by the relay UE, wherein the second direct communication request message is used to trigger the target UE to establish the communication link with the relay UE;
in response to the second direct communication request message, executing by the target UE, a second security mode command procedure with the relay UE; and
in response to completion of the second security mode command procedure, transmitting, by the target UE, a second direct communication accept message for the second direct communication request message to the relay UE.

13. The method according to claim 9, wherein the securely establishing, by the target UE, the end-to-end communication link with the source UE comprises:
executing, by the target UE, a third security mode command procedure with the source UE.

14. The method according to claim 9, wherein the method further comprises:
after the relay UE receives a third direct communication request transmitted by the source UE, receiving, by the target UE, a fourth direct communication request transmitted by the relay UE, wherein the fourth direct communication request is used to trigger the target UE to securely establish the end-to-end communication link with the source UE, and at least one of the third direct communication request or the fourth direct communication request comprises one or more of following information:
information for instructing securely establishing the end-to-end communication link; or
security data required for securely establishing the end-to-end communication link.

15. A communication method, comprising:
establishing, by a relay user equipment UE, a communication link with each of a source UE and a target UE; and
after the relay UE establishes the communication link with each of the source UE and the target UE, forwarding, by the relay UE, an end-to-end message between the source UE and the target UE, wherein the end-to-end message is used by the source UE to securely establish an end-to-end communication link with the target UE.

16. The method according to claim 15, wherein
the communication link between the source UE and the relay UE is a securely established communication link; and/or
the communication link between the relay UE and the target UE is a securely established communication link.

17. The method according to claim 15, wherein the establishing by the relay UE, the communication link with each of the source UE and the target UE comprises:
establishing, by the relay UE, the communication link with each of the source UE and the target UE under trigger of the source UE.

18. The method according to claim 15, wherein the establishing, by the relay UE, the communication link with each of the source UE and the target UE under trigger of the source UE comprises:
receiving, by the relay UE, a first direct communication request message transmitted by the source UE, wherein the first direct communication request message is used to trigger the relay UE to establish the communication link with the source UE;
executing, by the relay UE, a first security mode command procedure with the source UE;
transmitting, by the relay UE, a second direct communication request message to the target UE after the first security mode command procedure is completed, wherein the second direct communication request message is used to trigger the target UE to establish the communication link with the relay UE;
executing by the relay UE, a second security mode command procedure with the target UE;
receiving, by the relay UE, a second direct communication accept message for the second direct communication request message from the target UE after the second security mode command procedure is completed; and
in response to the second direct communication accept message, transmitting, by the relay UE, a first direct communication accept message for the first direct communication request message to the source UE.

19. The method according to claim 15, wherein before the executing by the source UE, the third security mode command procedure with the target UE, the method further comprises:
receiving, by the relay UE, a third direct communication request transmitted by the source UE before the source UE executes the third security mode command procedure with the target UE; and
in response to the third direct communication request, transmitting, by the relay UE, a fourth direct communication request to the target UE, wherein the fourth direct communication request is used to trigger the target UE to securely establish the end-to-end communication link with the source UE.

20. The method according to claim 15, wherein at least one of the third direct communication request or the fourth direct communication request comprises one or more of following information:
information for instructing securely establishing the end-to-end communication link; or
security data required for securely establishing the end-to-end communication link.
